(19) United States
(12) Patent Application Publication
(10) Pub. No.: US 2025/0300868 A1
(43) Pub. Date: Sep. 25, 2025

(54) COMMUNICATION METHOD, APPARATUS, AND SYSTEM, AND COMPUTER-RELATED PRODUCT

(71) Applicant: HUAWEI TECHNOLOGIES CO., LTD., Shenzhen (CN)

(72) Inventors: Ting WANG, Shanghai (CN); Hao TANG, Shanghai (CN); Na GAO, Shanghai (CN); Jianglei MA, Ottawa (CA)

(21) Appl. No.: 19/230,621

(22) Filed: Jun. 6, 2025

Related U.S. Application Data
(63) Continuation of application No. PCT/CN2022/138013, filed on Dec. 9, 2022.

(51) Int. Cl. H04L 27/26; H04B 7/06; H04W 72/044

(52) U.S. Cl. CPC H04L 27/261; H04B 7/0626; H04L 27/2607; H04W 72/044

(57) ABSTRACT

Embodiments of this application provide a communication method, apparatus, and system, and a computer-related product. The communication method may include: receiving a reference signal, where there is a first association relationship between information about the reference signal and scheduling information of data transmission; and performing the data transmission based on the scheduling information. According to embodiments of this application, association information of the scheduling information of the data transmission can be carried in the information about the reference signal, instead of performing transmission of the reference signal and the scheduling information separately. This can reduce overheads of the scheduling information, and reduce complexity and a latency of blind detection, thereby reducing a latency of the data transmission, and improving communication performance.

### CROSS-REFERENCE TO RELATED APPLICATIONS

This application is a continuation of International Application No. PCT/CN2022/138013, filed on Dec. 9, 2022, the disclosure of which is hereby incorporated by reference in its entirety.

### TECHNICAL FIELD

This application relates to the field of communication technologies, and in particular, to a communication method, apparatus, and system, and a computer-related product.

### BACKGROUND

In a protocol release 15 (Rel-15) specified in the 3rd generation partnership project (3GPP), before data transmission is performed between two communication apparatuses, a piece of scheduling information such as downlink control information (DCI) is sent, and the data transmission is performed based on indication of the scheduling information. For example, the two communication apparatuses are a network device and a terminal device. Before the network device schedules a data channel of the terminal device to perform data transmission, the network device sends a piece of DCI to the terminal device. The terminal device performs blind detection on the received DCI. During blind detection processing, channel estimation and data demodulation may be performed.

However, in a processing manner for the blind detection, the DCI in a plurality of formats is considered, and for the DCI in each format, after the blind detection fails, the blind detection is performed on the DCI in a next format until the blind detection succeeds. If the blind detection succeeds after a plurality of attempts, a latency increases. In addition, the DCI in the plurality of formats includes the DCI sent on a control channel element (CCE) group. A processing manner for performing blind detection on the DCI in this format is complex, and consequently, processing time is long.

### SUMMARY

Embodiments of this application disclose a communication method, apparatus, and system, and a computer-related product, to reduce overheads of scheduling information, and reduce complexity and a latency of blind detection, thereby reducing a latency of data transmission and improving communication performance.

According to a first aspect, an embodiment of this application discloses a first communication method. The method may be applied to a terminal device, an apparatus (for example, a chip, a chip system, or a circuit) in the terminal device, or an apparatus that can be used together with the terminal device. The method includes: receiving a reference signal, where there is a first association relationship between information about the reference signal and scheduling information of data transmission; and performing the data transmission based on the scheduling information.

According to a second aspect, an embodiment of this application discloses a second communication method. The method may be applied to a network device, an apparatus (for example, a chip, a chip system, or a circuit) in the network device, or an apparatus that can be used together with the network device. Alternatively, the method may be applied to a terminal device, an apparatus in the terminal device, or an apparatus that can be used together with the terminal device. The method includes: sending a reference signal, where there is a first association relationship between information about the reference signal and scheduling information of data transmission; and performing the data transmission based on the scheduling information.

According to a third aspect, an embodiment of this application discloses a first communication apparatus. The apparatus may include a terminal device, an apparatus in the terminal device, or an apparatus that can be used together with the terminal device. The apparatus includes: a transceiver unit, configured to receive a reference signal, where there is a first association relationship between information about the reference signal and scheduling information of data transmission; and the transceiver unit is further configured to perform the data transmission based on the scheduling information.

According to a fourth aspect, an embodiment of this application discloses a second communication apparatus. The apparatus may include a network device, an apparatus in the network device, or an apparatus that can be used together with the network device. Alternatively, the apparatus may include a terminal device different from the first communication apparatus, an apparatus in the terminal device, or an apparatus that can be used together with the terminal device. The apparatus includes: a transceiver unit, configured to send a reference signal, where there is a first association relationship between information about the reference signal and scheduling information of data transmission; and the transceiver unit is further configured to perform the data transmission based on the scheduling information.

In the first aspect, the second aspect, the third aspect, or the fourth aspect, the scheduling information is implicitly indicated by the reference signal, instead of performing transmission on the reference signal and the scheduling information separately. In comparison with a manner of separately sending the scheduling information, overheads of the scheduling information can be reduced, and complexity and a latency of blind detection can be reduced, thereby improving efficiency of the data transmission.

In the first aspect, the second aspect, the third aspect, or the fourth aspect, the scheduling information includes at least one of the following of the data transmission: a time domain resource, a frequency domain resource, a modulation scheme, a code rate, a transmission configuration indication, a repetition quantity, information about a demodulation reference signal, a pattern, a redundancy version, a new data indicator, transmission power information, or a transmission type indication.

In this application, a time domain resource and a frequency domain resource may be collectively referred to as a time-frequency resource. A unit of time domain may include a frame, a subframe, a slot, a sub-slot, a mini-slot, a symbol, or the like. A unit of frequency domain may include a subcarrier, a subcarrier spacing, a bandwidth, a resource block, a resource block group, a bandwidth part, or the like. The modulation scheme is used for data encoding and decoding. The modulation scheme may include at least one of a modulation scheme in a modulation and coding scheme (MCS), orthogonal frequency division multiplexing (OFDM), quadrature phase shift keying (QPSK), quadrature amplitude modulation (QAM), or the like.

The transmission configuration indication (TCI) of the data transmission, and may indicate configuration information of the data transmission. The transmission type indication may indicate whether data whose transmission is performed is uplink data or downlink data, indicate whether the data is sent data or received data, indicate that the data is sent sidelink data, indicate that the data is received sidelink data, or the like.

The transmission power information may indicate power information of the data transmission, and is applicable to a physical uplink shared channel (PUSCH). For example, a transmission power control (TPC) command for PUSCH scheduling (TPC command for scheduled PUSCH) instructs the terminal device to adjust transmission power of the PUSCH. The information about the demodulation reference signal may include at least one of a sequence indication, a scrambling identifier indication, power information, or the like.

The repetition quantity is equal to a sum of a quantity of initial transmissions and a quantity of repeated transmissions. The pattern of the data transmission indicates content of the data transmission, for example, a transmission type, the repetition quantity, and the information about the demodulation reference signal that are of the data transmission. The redundancy version (RV) is used to determine bit content of the data transmission. The new data indicator (NDI) indicates whether transmission of scheduled data is new transmission or retransmission.

With reference to the first aspect, the second aspect, the third aspect, or the fourth aspect, in some feasible examples, the information about the reference signal includes at least one of the following of the reference signal: a signal class, a sequence parameter, a time domain resource, a frequency domain resource, a transmission configuration indication, or a pattern.

.Optionally, the transmission configuration indication of the reference signal may be the same as the transmission configuration indication of the data transmission. In this way, large-scale channels for transmission of the data and the reference signal are the same, so that the scheduling information can be simplified, and accuracy of channel estimation can be improved.

The pattern of the reference signal may indicate content of the reference signal, namely, a time-frequency resource occupied by the reference signal. The pattern of the reference signal, for example, the signal class, a repetition quantity, or information about a demodulation reference signal of the reference signal, may be used for data channel estimation and data demodulation. For the signal class, the sequence parameter, the time domain resource, and the frequency domain resource that are of the reference signal, refer to subsequent examples. Details are not described herein.

Optionally, a resource element (RE) location of the reference signal may be configured by the network device, and obtained by the terminal device based on configured information; or the RE location is obtained by the terminal device by performing blind detection on the reference signal.

Optionally, there may be a correspondence between the RE location of the reference signal and an antenna port number. For example, a first RE location corresponds to port 0 and/or port 1, a second RE location corresponds to port 2 and/or port 3, and a third RE location corresponds to port 4 and/or port 5. In this way, the time domain resource for the data transmission can be determined based on the RE location of the reference signal and the correspondence between the RE location of the reference signal and the port number.

Optionally, there is a first association relationship between the scheduling information and at least one of the following of the reference signal: the RE location, the port number, or the sequence parameter. In this way, the scheduling information can be determined based on at least one of the RE location, the port number, or the sequence parameter, and the first association relationship between the scheduling information and at least one of the RE location, the port number, or the sequence parameter, so that the data transmission can be performed based on the scheduling information.

Optionally, the network device configures a sequence group and/or a sequence number based on whether the terminal device supports sequence group hopping and sequence hopping.

With reference to the first aspect, the second aspect, the third aspect, or the fourth aspect, in some feasible examples, the signal class of the reference signal includes at least one of the following: a channel state information reference signal (CSI-RS), a demodulation reference signal (DMRS), a phase tracking reference signal (PT-RS), a sounding reference signal (SRS), or a reference signal downlink control information (RS DCI).

With reference to the first aspect, the second aspect, the third aspect, or the fourth aspect, in some feasible examples, the sequence parameter includes at least one of the following of a sequence: a sequence type, a scrambling identifier, a root identifier, or a cyclic shift.

The sequence type may include a pseudo-random sequence, a const amplitude zero auto-correlation (CAZAC) sequence, or the like, for example, a pseudo noise (PN) code or a Zadoff-Chu sequence (namely, a ZC sequence). The root identifier may also be referred to as a root sequence index. The root identifier and the cyclic shift are used to generate a preamble sequence of each cell, and may be used to ensure that preamble sequences used by adjacent cells are different. The scrambling identifier may include one or more of a user identifier (for example, a user number or a UE number), a user group identifier, or a cell identifier. The scrambling identifier may be used to perform interference randomization on the sequence.

With reference to the first aspect, the second aspect, the third aspect, or the fourth aspect, in some feasible examples, a time-frequency resource for the data transmission and a time-frequency resource for the reference signal meet at least one of the following: the frequency domain resource for the data transmission is the same as the frequency domain resource for the reference signal; the information about the reference signal indicates that there is a frequency domain offset between the frequency domain resource for the data transmission and the frequency domain resource for the reference signal; the time domain resource for the data transmission is the same as the time domain resource for the reference signal; or the information about the reference signal indicates that there is a time domain offset between the time domain resource for the data transmission and the time domain resource for the reference signal. In this way, an association relationship between the time-frequency resource for the reference signal and the time-frequency resource for the data transmission can be obtained, so that the time-frequency resource for the data transmission can be determined based on the time-frequency resource for the reference signal.

Values of the time domain offset and the frequency domain offset are not limited in this application. For example, a quantity of resource blocks of the frequency domain offset may be f₁, where f₁ is an integer. Optionally, f₁ may be an integer greater than or equal to 0 and less than or equal to 4. For another example, if a number of a symbol in which the reference signal is located is l₁, the time domain resource for the data transmission may be in a symbol following the time domain resource for the reference signal, and a symbol number of the time domain resource for the data transmission may be l₁+r₁, where r₁ is an integer. Optionally, r₁ may be an integer greater than or equal to 0 and less than or equal to 4.

Optionally, when one single data transmission occupies one symbol, r₁ may be a repetition quantity. When the single data transmission occupies d symbols, r₁ may be d*the repetition quantity. It should be understood that the time domain resource for the data transmission may be related to a quantity of symbols for one single data transmission and a repetition quantity, so that the time domain resource for the data transmission can be flexibly determined based on the quantity of symbols for the single data transmission and the repetition quantity, improving communication performance.

With reference to the first aspect, the second aspect, the third aspect, or the fourth aspect, in some feasible examples, the time domain resource for the data transmission includes a quantity of time domain symbols occupied for one single data transmission, and the information about the reference signal indicates the quantity of time domain symbols. In this way, data whose transmission is performed can be determined based on the quantity of time domain symbols occupied for the single data transmission, to implement channel estimation and demodulation for a data channel.

Optionally, the quantity of time domain symbols is predefined in a protocol, or the device that sends the reference signal may notify, via signaling, the device that receives the reference signal of the quantity of time domain symbols. For example, the first device may configure a plurality of candidate values of the quantity of time domain symbols occupied for the single data transmission, and there is a correspondence between the RE location of the reference signal and the plurality of candidate values of the quantity of time domain symbols, so that the quantity of time domain symbols occupied for the single data transmission can be determined based on the RE location of the reference signal.

With reference to the first aspect, in some feasible examples, the method further includes: receiving configuration information; and receiving the reference signal based on the configuration information.

With reference to the second aspect, in some feasible examples, the method further includes: sending configuration information; and sending the reference signal based on the configuration information.

With reference to the third aspect, in some feasible examples, the transceiver unit is further configured to: receive configuration information; and receive the reference signal based on the configuration information.

With reference to the fourth aspect, in some feasible examples, the transceiver unit is further configured to: send configuration information; and send the reference signal based on the configuration information.

The configuration information indicates one or more candidate values of the information about the reference signal, and there is a second association relationship between the candidate value and the one or more pieces of scheduling information; or the configuration information indicates a second association relationship, and the second association relationship indicates one or more candidate values of the information about the reference signal. The second association relationship includes the first association relationship.

It may be understood that, in the foregoing examples, the configuration information explicitly or implicitly carries the candidate value of the information about the reference signal. Transmission of the reference signal is performed based on the candidate value in the configuration information, and the second association relationship is obtained. Therefore, after the reference signal is received, blind detection is performed on the reference signal to obtain the value of the information about the reference signal. This can improve blind detection efficiency and accuracy.

Optionally, the candidate value of the information about the reference signal may be predefined in a protocol, or may be notified by the network device to the terminal device via signaling. There is a correspondence between the candidate value of the information about the reference signal and at least one of the RE location, the port number, the sequence parameter, or the like of the reference signal. In this way, the candidate value can be determined based on at least one of the RE location, the port number, the sequence parameter, or the like of the reference signal, and the correspondence between the candidate value of the information about the reference signal and at least one of the RE location, the port number, the sequence parameter, or the like of the reference signal.

With reference to the first aspect, in some feasible examples, the method further includes: determining a transmission type of the data transmission based on the signal class of the reference signal.

With reference to the third aspect, in some feasible examples, the communication apparatus further includes a processing unit, configured to determine a transmission type of the data transmission based on the signal class of the reference signal.

For example, when the reference signal is an SRS, it is determined that the transmission type of the data is uplink transmission, and the data is sent data; or when the reference signal is a DMRS, it is determined that the transmission type of the data is downlink transmission, and the data is received data. In this way, in the foregoing examples, the transmission type of the data transmission is determined based on the determined signal class of the reference signal, and then the data transmission is performed.

Optionally, for uplink data transmission, the reference signal may be an SRS, and may be used as a scheduling request to carry scheduling information. In addition, for a data transmission requirement with a latency of 0.1 ms, the SRS may be further used as a channel estimation and demodulation reference signal of uplink data, to reduce pilot overheads.

With reference to the first aspect, in some feasible examples, the method further includes: the scheduling information includes first information and second information; and the method further includes: determining the second information based on the first information and a third association relationship.

With reference to the second aspect or the fourth aspect, in some feasible examples, the scheduling information includes first information and second information.

With reference to the third aspect, in some feasible examples, the scheduling information includes first information and second information; and the communication apparatus further includes a processing unit, configured to determine the second information based on the first information and a third association relationship.

There is the third association relationship between the first information and the second information. In this way, the second information in the scheduling information is determined based on the first information in the scheduling information and the third association relationship, so that the information about the reference signal can be associated with the first information, while the reference signal may not be associated with the second information. This helps reduce signaling overheads and improve efficiency of determining the scheduling information.

According to a fifth aspect, an embodiment of this application provides a third communication apparatus. The communication apparatus may be a terminal device, an apparatus in the terminal device, or an apparatus that can be used together with the terminal device. The communication apparatus may include a processor. The processor is configured to enable, by executing instructions in a memory or by using a logic circuit, the communication apparatus to perform the communication method described in any one of the first aspect or the feasible examples of the first aspect.

According to a sixth aspect, an embodiment of this application provides a fourth communication apparatus. The communication apparatus may be a network device, an apparatus in the network device, or an apparatus that can be used together with the network device. The communication apparatus may be a terminal device, an apparatus in the terminal device, or an apparatus that can be used together with the terminal device. The communication apparatus may include a processor. The processor is configured to enable, by executing instructions in a memory or by using a logic circuit, the communication apparatus to perform the communication method described in any one of the second aspect or the feasible examples of the second aspect.

With reference to the fifth aspect or the sixth aspect, in some feasible examples, the communication apparatus further includes one or more of a memory or a transceiver, and the transceiver is configured to receive and send data and/or signaling.

According to a seventh aspect, this application provides a communication system. The communication system includes a terminal device and a network device. When running in the communication system, the terminal device and the network device are configured to perform any communication method in the first aspect and the second aspect.

According to an eighth aspect, this application provides another communication system. The communication system includes a first terminal device and a second terminal device. When running in the communication system, the first terminal device and the second terminal device are configured to perform any communication method in the first aspect and the second aspect.

According to a ninth aspect, this application provides a computer-readable storage medium. The computer-readable storage medium stores instructions. When the instructions are executed by a processor, the communication method described in any one of the first aspect, the second aspect, or the feasible examples of the first aspect and the second aspect is performed.

According to a tenth aspect, this application provides a computer program product. The computer program product includes instructions. When the instructions are executed by a processor, the communication method described in any one of the first aspect, the second aspect, or the feasible examples of the first aspect and the second aspect is performed.

According to an eleventh aspect, this application provides a third communication method, including the communication method described in any one of the first aspect, the second aspect, or the feasible examples of the first aspect and the second aspect.

It should be understood that mutual reference may be made to the implementations and beneficial effects of the foregoing aspects of this application.

### BRIEF DESCRIPTION OF DRAWINGS

The following describes accompanying drawings used in embodiments of this application.

FIG. 1 is a diagram of an architecture of a communication system according to an embodiment of this application;

FIG. 2A, FIG. 2B, and FIG. 2C are each a diagram of a structure of a control resource set according to an embodiment of this application;

FIG. 3 is a diagram of interaction of a communication method according to an embodiment of this application;

FIG. 4, FIG. 5, and FIG. 6 are each a diagram of a pattern of data transmission according to an embodiment of this application;

FIG. 7 is a diagram of locations of resource elements in which three reference signals are located according to an embodiment of this application;

FIG. 8 is a diagram of a frequency domain offset according to this application;

FIG. 9 is a diagram of a structure of a communication apparatus according to an embodiment of this application;

FIG. 10 is a diagram of a structure of another communication apparatus according to an embodiment of this application; and

FIG. 11 is a diagram of a structure of a terminal device according to an embodiment of this application.

### DESCRIPTION OF EMBODIMENTS

The technical solutions in embodiments of this application may be applied to various communication systems, for example, a long term evolution (LTE) system, a new radio (NR) system, a public land mobile network (PLMN) system, a long term evolution-advanced (LTE-A) system, a device-to-device (D2D) communication system, a machine-to-machine (M2M) communication system, an internet of things (IoT) system, a narrowband-internet of things (NB-IoT) system, an integrated sensing and communication system, a frequency division duplex (FDD) system, a time division duplex (TDD) system, a non-terrestrial communication (NTN) system, a wireless projection communication system, an integrated access and backhaul (IAB) communication system, a communication system (for example, a 6G communication system) evolved from 5G, and a non-3GPP communication system. This is not limited.

The NTN system may be a satellite communication system, and the non-terrestrial communication device may provide a communication service for a terminal device. For example, the non-terrestrial communication device encodes data through channel coding, performs constellation modulation, and transmits downlink data obtained through the constellation modulation to the terminal device. For another example, the terminal device encodes data through channel coding, performs constellation modulation, and sends uplink data obtained through the constellation modulation to the non-terrestrial communication device. The non-terrestrial communication device may be used as a base station, or may be used as a terminal device. The non-terrestrial communication device may include a high-altitude platform (HAP), an uncrewed aerial vehicle, a hot air balloon, a low-orbit satellite, a medium-orbit satellite, a high-orbit satellite, or the like, or may be a non-ground base station or a non-ground terminal.

The IAB communication system may include an IAB parent node (IAB Donor), an IAB node, and a terminal device. A link between the IAB parent node and the IAB node is a backhaul link, and a link between the terminal device and the IAB node is an access link.

A communication method provided in embodiments of this application may be applied to various communication scenarios, for example, may be applied to one or more of the following communication scenarios: enhanced mobile broadband (eMBB), ultra-reliable low-latency communication (URLLC), machine type communication (MTC), massive machine type communication (mMTC), enhanced machine type communication (eMTC), IoT, NB-IoT, customer premise equipment (CPE), augmented reality (AR), virtual reality (VR), D2D, V2X, and the like.

FIG. 1 is a diagram of an architecture of a communication system according to an embodiment of this application. As shown in FIG. 1, the communication system may include a terminal device 101 and a network device 102. The terminal device 101 may be connected to the network device 102 in a wireless manner. The terminal device 101 may be at a fixed location, or may be movable. The terminal device 101 and the network device 102 may be deployed on land, for example, deployed as indoor or outdoor devices, handheld or vehicle-mounted devices, or the like. Alternatively, the terminal device 101 and the network device 102 may be deployed on a water surface, an airplane, a balloon, and a satellite in the air, or the like. This is not limited herein.

Communication between the terminal device 101 and the network device 102, between the network devices 102, and between the terminal devices 101 may be performed by using a licensed spectrum, or by using an unlicensed spectrum or by using both a licensed spectrum and an unlicensed spectrum. Spectrum resources (frequency domain resources) used by the terminal device 101 and the network device 102 are not limited in this application.

The terminal device 101 may be a user-side entity configured to receive or transmit a signal. The terminal device 101 may be a mobile phone, a tablet computer, a computer with a wireless transceiver function, a VR terminal device, an AR terminal device, a CPE, an IoT terminal, a wireless terminal in industrial control, a wireless terminal in self-driving, a wireless terminal in telemedicine, a wireless terminal in a smart grid, a wireless terminal in transportation safety, a wireless terminal in a smart city, a wireless terminal in a smart home, a terminal in integrated sensing and communication, a vehicle-mounted terminal, a vehicle with a V2X communication capability, an intelligent connected vehicle, an uncrewed aerial vehicle with an uncrewed aerial vehicle to uncrewed aerial vehicle (UAV to UAV, U2U) communication capability, a personal digital assistant (PDA), a wireless communication module/chip in various devices such as a smart factory or a smart grid, or the like. This is not limited herein.

The terminal device 101 may be sometimes referred to as user equipment (UE), a terminal, an access terminal, a UE unit, a UE station, a mobile device, a mobile station, a mobile terminal, a mobile client, a mobile unit, a remote station, a remote terminal device, a remote unit, a wireless unit, a wireless communication device, a user agent, a user apparatus, or the like. The access terminal may be a cellular phone, a cordless phone, a session initiation protocol (SIP) phone, a wireless local loop (WLL) station, a PDA, a handheld device with a wireless communication function, a computing device, another processing device connected to a wireless modem, a vehicle-mounted device, a wearable device, a terminal device in a PLMN evolved from 5G, a terminal device in a non-public network (NPN) evolved from 5G, or the like. In a 5G communication system, the terminal device 101 establishes a signal connection and a data connection to the network device 102 by using a new radio technology, for transmission of a control signal and service data to a data network.

The network device 102 may be an entity configured to transmit or receive a signal, and is mainly configured to implement functions such as a radio physical control function, resource scheduling and radio resource management, radio access control, and mobility management, and provide a reliable radio transmission protocol, a reliable data encryption protocol, and the like. The network device may support wired access, or may support wireless access, and may be referred to as an access network device below.

Optionally, the access network device may be an access network (AN)/radio access network (RAN) device, and includes a plurality of AN/RAN nodes. The AN/RAN node may include but is not limited to: an access point (AP), an enhanced NodeB (eNB), a home NodeB (for example, a home evolved NodeB, or a home NodeB, HNB), a baseband unit (BBU), a next generation base station (gNB), a transmission reception point (TRP), a transmission point (TP), or another access node, for example, a wireless relay node or a wireless backhaul node. Alternatively, the AN/RAN node may be an antenna panel formed by one or more antenna units, or may be a network node that forms a gNB or a transmission point, for example, a BBU or a distributed unit (DU), or may be a device that undertakes a base station function in a communication system like D2D, V2X, M2M, or U2U, or the like. The AN/RAN node may be a radio controller in a cloud radio access network (CRAN) scenario, or may be a base station in a communication system evolved from 5G, for example, an xNodeB in a 6G communication system, or may be an access network device in a PLMN network evolved from 5G. This is not limited herein.

Main functions of the access network device include: radio resource management, compression of an internet protocol (IP) header, encryption of a subscriber data flow, selection of a mobility management entity (MME) when user equipment is attached, routing of user plane data to a service gateway (SGW), organization and sending of a paging message, organization and sending of a broadcast message, measurement for mobility or scheduling purposes and configuration of a measurement report, and the like. A protocol stack architecture and the functions of the access network device are divided into two parts. One part is referred to as a central unit (CU), and the other part is referred to as a DU. Such a network device may be referred to as a RAN device including a CU node and a DU node.

The network device may further include a core network device, configured to: maintain subscription data of a mobile network, manage a network element of the mobile network, and provide functions such as session management, mobility management, policy management, and security authentication for the terminal device.

In embodiments of this application, the terminal device or the network device includes a hardware layer, an operating system layer running on the hardware layer, and an application layer running on the operating system layer. The hardware layer includes hardware such as a central processing unit (CPU), a memory management unit (MMU), and a memory (which may also be referred to as a main memory). The operating system may be any one or more computer operating systems that implement service processing by using a process, for example, a Linux operating system, a Unix operating system, an Android operating system, an iOS operating system, or a Windows operating system. The application layer includes applications such as a browser, an address book, word processing software, and instant messaging software. In addition, a specific structure of an execution body of a method provided in embodiments of this application is not particularly limited in embodiments of this application, provided that a program that records code of the method provided in embodiments of this application can be run to perform communication according to the method provided in embodiments of this application. For example, the execution body of the method provided in embodiments of this application may be a terminal device or a network device, or a functional module in the terminal device or the network device that can invoke and execute the program.

In addition, aspects or features of this application may be implemented as a method, an apparatus, or a product that uses standard programming and/or engineering technologies. The term “product” used in this application covers a computer program that can be accessed from any computer-readable device, carrier, or medium. For example, the computer-readable medium may include but is not limited to a magnetic storage device (for example, a hard disk, a floppy disk, or a magnetic tape), an optical disc (for example, a compact disc (CD) or a digital versatile disc (DVD)), a smart card, and a flash memory component (for example, an erasable programmable read-only memory (EPROM), a card, a stick, or a key drive). Various storage media described in this specification may represent one or more devices and/or other machine-readable media configured to store information. The term “machine-readable medium” may include but is not limited to a radio channel and various other media that can store, include, and/or carry instructions and/or data.

It should be noted that quantities and types of network devices and terminal devices included in the network architecture shown in FIG. 1 are merely examples, and embodiments of this application are not limited thereto. For example, more or fewer terminal devices that communicate with the network device may be included. For example, more or fewer core network devices that communicate with the network device may be included. For brevity of description, the devices are not described one by one in the accompanying drawings. In addition, in the network architecture shown in FIG. 1, although the network device and the terminal device are shown, the application scenario may include but is limited to the network device and the terminal device, for example, may further include a device configured to carry a virtualized network function. This is obvious to a person skilled in the art, and details are not described herein again.

For ease of understanding embodiments of this application, the following first provides definitions of technical terms that may appear in embodiments of this application. Terms used in implementations of this application are only used to explain specific embodiments of this application, but are not intended to limit this application.
(1) Control resource set (CORESET): A CORESET is a resource set of control information, includes a set of resource grids, and further includes some parameter sets (DCI). One CORESET includes one or more CCEs, and one CCE may include a plurality of resource element groups (REG) (for example, six REGs). The REG is a resource unit assigned for a control channel resource, and includes 12 consecutive RE locations in frequency domain, and one symbol in time domain. An RE is a minimum resource unit, and includes one symbol in time domain, and one subcarrier in frequency domain.

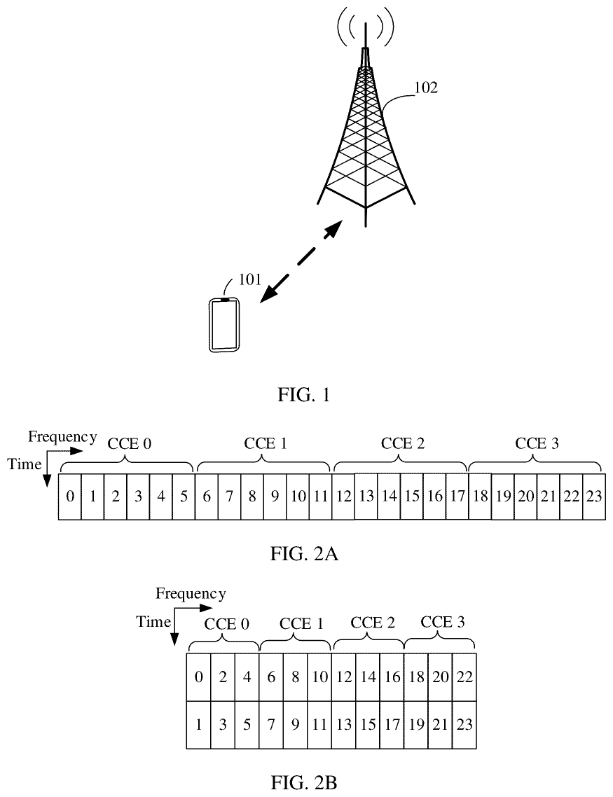

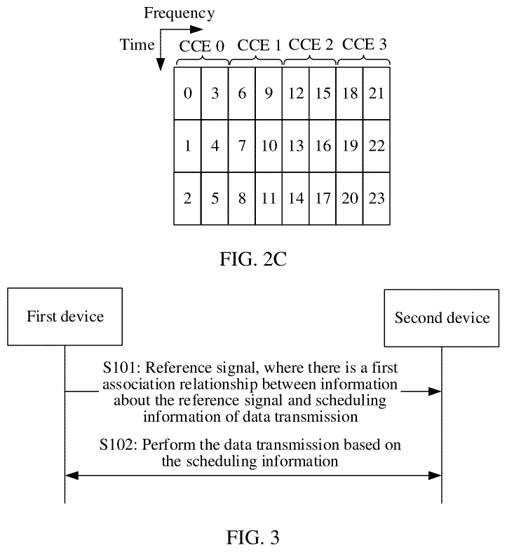

For a diagram of a structure of a CORESET, refer to FIG. 2A, FIG. 2B, and FIG. 2C. In FIG. 2A, FIG. 2B, and FIG. 2C, a horizontal axis represents a frequency, a vertical axis represents time, each block represents one REG, and one CCE includes six REGs. A CORESET shown in FIG. 2A may be referred to as a single-symbol CORESET. A CCE in the CORESET includes one single symbol in time domain, and includes six REGs in frequency domain. A CORESET shown in FIG. 2B may be referred to as a two-symbol CORESET. A CCE in the CORESET includes two symbols in time domain, and includes three REGs in frequency domain. A CORESET shown in FIG. 2C may be referred to as a three-symbol CORESET. A CCE in the CORESET includes three symbols in time domain, and includes two REGs in frequency domain.
(2) DCI: Transmission of downlink control information of one or more cells is

performed by using a radio network temporary identifier(RNTI), and the following coding steps may be included: information element multiplexing, cyclic redundancy check (CRC) scrambling, channel coding, and rate matching.

Based on different content of the control information, the DCI may be divided into a plurality of DCI formats.

For example, a configuration in NR is as follows: DCI formats include a DCI format 0_0, a DCI format 0_1, a DCI format 1_0, a DCI format 1_1, a DCI format 2_0, a DCI format 2_1, a DCI format 2_2, a DCI format 2_3, and the like. The DCI format 0_0 and the DCI format 0_1 are responsible for PUSCH scheduling, and the DCI format 1_0 and the DCI format 1_1 are responsible for physical downlink shared channel (PDSCH) scheduling. The DCI format 2_0 is responsible for notifying a group of terminal devices of a slot format. The DCI format 2_1 is responsible for notifying a group of terminal devices of an unavailable physical resource block (PRB) and an unavailable OFDM symbol. The DCI format 2_2 is responsible for TPC commands for physical uplink control channel (PUCCH) and PUSCH scheduling. The DCI format 2_3 is responsible for TPC commands for a group of sounding reference signals (SRSs) of one or more terminal devices.

The DCI formats may further include a DCI format 0_2, a DCI format 1_2, and the like. This is not limited herein. The DCI format 0_2 and the DCI format 1_2 are user-specific scheduling information and are applicable to ultra-reliable low-latency communication (URLLC), and can implement downlink PDSCH and uplink PUSCH scheduling. Information fields of non-zero bits in the DCI format 0_2 and the DCI format 1_2 may include a downlink/uplink indication (header/identifier for DCI format), a frequency domain resource assignment, an MCS, an NDI, and a TPC command for PUSCH scheduling.

When the downlink/uplink indication is set to 1, it indicates that downlink data transmission is scheduled, that is, the terminal device receives data; or it indicates that uplink data transmission is scheduled, that is, the terminal device sends data. The frequency domain resource assignment indicates a resource block for data transmission. MCS identifiers may range from 0 to 31, where MCS identifiers 29 to 31 are reserved, and the three combinations are used only for retransmission. The DCI indicates, by using a 5-bit MCS identifier, a modulation and coding scheme used for current transmission. The NDI indicates whether transmission of scheduled data is new transmission or retransmission. A transmission power control command for PUSCH scheduling instructs the terminal device to adjust transmission power of a PUSCH.

A quantity of CCEs occupied for transmission of one piece of DCI may be 1, 2, 4, 6, or the like. An aggregation level indicates a quantity of CCEs assigned to one physical downlink control channel (PDCCH). For example, if the aggregation level is 4, it indicates that four CCEs are assigned to one PDCCH. During blind detection, in a protocol, the CCEs are divided into a common search space and a specific search space of the terminal device. Different information is searched for in different spaces. If an aggregation level in the common search space is 4 or 8, during search, the terminal device may first search for the DCI by using four CCEs as a granularity, and then search for the DCI by using eight CCEs as a granularity.

An NR protocol specifies a maximum quantity of PDCCH blind detections in one slot. Refer to Table 1. Table 1 is used to describe an association relationship between a subcarrier spacing and a maximum quantity of PDCCH blind detections in one slot. As shown in Table 1, in a subcarrier spacing of 15 kHz, the maximum quantity of PDCCH blind detections in one slot is 44; in a subcarrier spacing of 30 kHz, the maximum quantity of PDCCH blind detections in one slot is 36; in a subcarrier spacing of 60 kHz, the maximum quantity of PDCCH blind detections in one slot is 22; and in a subcarrier spacing of 120 kHz, the maximum quantity of PDCCH blind detections in one slot is 20.

TABLE 1

| Subcarrier spacing | 15 kHz | 30 kHz | 60 kHz | 120 kHz |
|---|---|---|---|---|
| Maximum quantity of | 44 | 36 | 22 | 20 |
| PDCCH blind | | | | |
| detections in one slot | | | | |

The terminal device may extract data from the CORESET, sequentially perform de-rate matching and Viterbi decoding on the data, and then compare the data with a specific RNTI mask through CRC check. If the data is the same as the RNTI mask, it indicates that the DCI of the terminal device is detected, and blind detection of the DCI succeeds. Channel estimation and data demodulation may be performed based on the DCI, to send data and/or receive data. If the data is different from the RNTI mask, the foregoing steps may be performed on data at a next location until it is detected that the blind detection of the DCI succeeds. Because the terminal device does not know a quantity of CCEs occupied by the DCI, the blind detection needs to be performed in corresponding manners for different quantities of CCEs. However, indication signaling overheads in scheduling information sent on a CCE group are high. For example, resource information, an MCS, and the like need to be indicated for data transmission of each communication pair. Consequently, a blind detection mode by using a CCE group is complex, and processing time is long. If the blind detection succeeds after a plurality of attempts, a latency increases.

Based on this, this application proposes a communication method, so that association information of scheduling information of data transmission can be carried in information about a reference signal, instead of performing transmission on the reference signal and the scheduling information separately. This can reduce overheads of the scheduling information, and reduce complexity and a latency of blind detection, thereby reducing a latency of the data transmission, and improving communication performance.

FIG. 3 is a diagram of interaction of a communication method according to an embodiment of this application. A first device in FIG. 3 may be a network device or a terminal device, and a second device may be a terminal device. If the first device is a terminal device A, the second device may be a terminal device B, and the terminal device B is different from the terminal device A. The terminal device in this embodiment may be the terminal device in the network architecture shown in FIG. 1. A function performed by the terminal device in this embodiment may be performed by an apparatus (for example, a chip, a chip system, or a circuit) in the terminal device, or may be an apparatus that can be used together with the terminal device. The network device in this embodiment may be the network device in the network architecture shown in FIG. 1. A function performed by the network device in this embodiment may be performed by an apparatus (for example, a chip, a chip system, or a circuit) in the network device, or may be an apparatus that can be used together with the network device. The communication method includes but is not limited to the following step S101 and step S102.

Step S101: The first device sends a reference signal to the second device, where there is a first association relationship between information about the reference signal and scheduling information of data transmission.

Correspondingly, the second device receives the reference signal from the first device.

In embodiments of this application, the reference signal (RS) may be a pilot signal, and is a known signal provided by a transmit end for a receive end for channel estimation or channel sounding. In some feasible examples, a signal class of the reference signal may include at least one of a CSI-RS, a DMRS, a PT-RS, an SRS, an RS DCI, or the like. This is not limited herein.

The CSI-RS is used for downlink channel measurement, downlink channel state information obtaining, beam management, radio resource management (RRM) measurement/radio link monitoring (RLM) measurement, refined time-frequency tracking, mobility management, rate matching, and the like. The DMRS is used for channel estimation to demodulate a corresponding physical channel, for example, a PDSCH, a PUSCH, a PDCCH, or a PUCCH. The PT-RS is used for phase noise tracking and compensation. The SRS is used for uplink channel measurement, time-frequency synchronization, beam management, and the like. The RS DCI is a reference signal including DCI, and information about the reference signal and the scheduling information of the data transmission have the first association relationship. In this way, transmission of the reference signal and the scheduling information does not need to be performed separately, and the RS DCI may be understood as simplified scheduling information.

In embodiments of this application, the scheduling information may also be referred to as control information, and indicates how data transmission is performed.

In some feasible examples, the scheduling information may include at least one of the following of the data transmission: a time domain resource, a frequency domain resource, a modulation scheme, a code rate, a transmission configuration indication, a repetition quantity, information about a demodulation reference signal, a pattern, a redundancy version, a new data indicator, transmission power information, a transmission type indication, or the like. This is not limited herein.

The time domain resource and the frequency domain resource may be collectively referred to as a time-frequency resource. A unit of the time domain resource may include a frame, a subframe, a slot, a sub-slot, a mini-slot, a symbol, or the like. A unit of the frequency domain resource may include a subcarrier, a subcarrier spacing, a bandwidth, a resource block (RB), a resource block group (RBG), a bandwidth part (BWP), or the like. The time-frequency resource may include at least one of the following: a time domain resource, a frequency domain resource, an RE, or the like.

The modulation scheme is used for data encoding and decoding. The modulation scheme may include at least one of a modulation scheme in an MCS, OFDM, QPSK, QAM, or the like. This is not limited herein. The transmission configuration indication of the data transmission may indicate configuration information of the data transmission, for example, indicate that the TCI of the data transmission is the same as a TCI of the reference signal, or indicate that the TCI of the data transmission is a TCI of a first reference signal. The transmission type indication may indicate whether data whose transmission is performed is uplink data or downlink data, indicate whether the data is sent data or received data, indicate that the data is sent sidelink data, indicate that the data is received sidelink data, or the like.

The transmission power information may indicate power information of the data transmission, and is applicable to a PUSCH. For example, a TPC command for PUSCH scheduling instructs the terminal device to adjust transmission power of the PUSCH. The information about the demodulation reference signal may include at least one of the following: a sequence indication, a scrambling identifier indication, power information, or the like.

The repetition quantity may be equal to a sum of a quantity of initial transmissions and a quantity of repeated transmissions. When the repetition quantity is 1, it indicates that initial transmission is performed, and repeated transmission is not performed. When the repetition quantity is greater than 1, it indicates that initial transmission and repeated transmission are performed, and for each piece of data whose retransmission is performed, bits for data transmission may be determined by using a different RV. The RV is designed to implement incremental redundancy (IR) HARQ transmission. To be specific, redundant bits generated by an encoder are divided into several groups, each RV defines a transmission start point, and different RVs are used for initial transmission and all HARQ retransmission, to implement gradual accumulation of redundant bits and complete an incremental redundancy HARQ operation. For example, the RV may include {0, 0, 0, 0}, {0, 2, 3, 1}, {0, 3, 0, 3}, or the like. This is not limited herein.

Optionally, the reference signal may schedule blind retransmission of data, so that the terminal device may not perform positive feedback or negative feedback (ACK/NACK) after receiving the data. Therefore, the reference signal may not include transmission power information of feedback information, so that power configuration information of a PUCCH or a PUSCH is not indicated, thereby reducing a latency, and reducing feedback overheads.

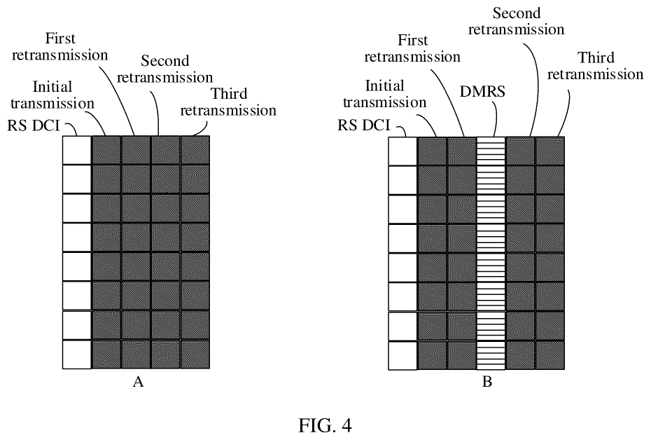

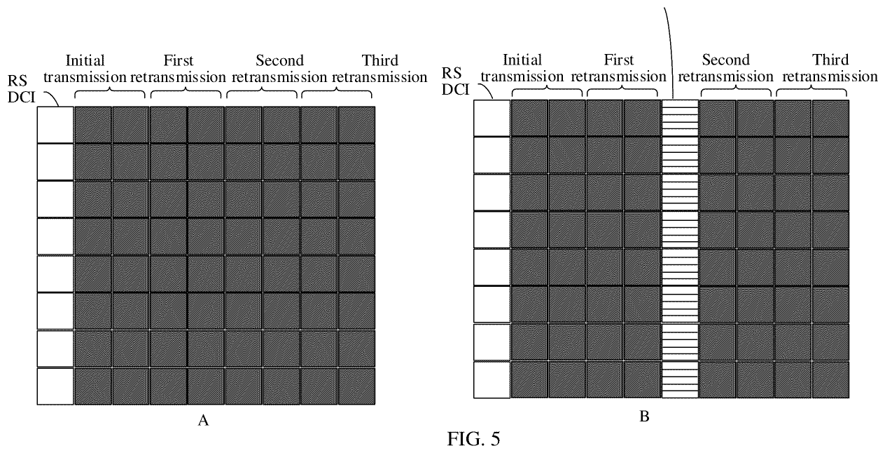

The pattern of the data transmission indicates content of the data transmission, for example, a transmission type, the repetition quantity, and the information about the DMRS that are of the data transmission. The repetition quantity of the data transmission and a location of the DMRS are not limited in this application. For example, repetition quantities in FIG. 4 and FIG. 5 are 4, a repetition quantity in FIG. 6 is 5, and locations of DMRSs in A and B in FIG. 6 are different.

For example, refer to FIG. 4, FIG. 5, and FIG. 6. A resource represented by an unfilled box in FIG. 4, FIG. 5, and FIG. 6 indicates a signal class of a reference signal, for example, an RS DCI. In FIG. 4, FIG. 5, and FIG. 6, a resource represented by a box filled with gray is used for transmission of data, and a resource represented by a box with horizontal lines is used for transmission of a DMRS of data. FIG. 4 shows a pattern in which single-symbol transmission is repeated four times, FIG. 5 shows a pattern in which dual-symbol transmission is repeated four times, and FIG. 6 shows a pattern in which single-symbol transmission is repeated five times. As shown in B in FIG. 5 and A and B in FIG. 6, when the pattern of the data transmission includes the DMRS, channel estimation and demodulation may be performed based on the RS DCI and the DMRS. As shown in A in FIG. 4 and A in FIG. 5, when the pattern of the data transmission does not include the DMRS, channel estimation and demodulation may be performed based on the RS DCI.

In some feasible examples, the information about the reference signal may include at least one of the following of the reference signal: a signal class, a sequence parameter, a time domain resource, a frequency domain resource, a transmission configuration indication, a pattern, or the like.

The signal class of the reference signal may include one or more of a CSI-RS, a DMRS, a PT-RS, an SRS, an RS DCI, or the like. For the time domain resource and the frequency domain resource, refer to the foregoing descriptions. Details are not described herein again. The transmission configuration indication of the reference signal is a TCI of the reference signal. Optionally, the transmission configuration indication of the reference signal may be the same as the transmission configuration indication of the data transmission. In this way, large-scale channels for transmission of the data and the reference signal are the same, so that the scheduling information can be simplified, and accuracy of channel estimation can be improved.

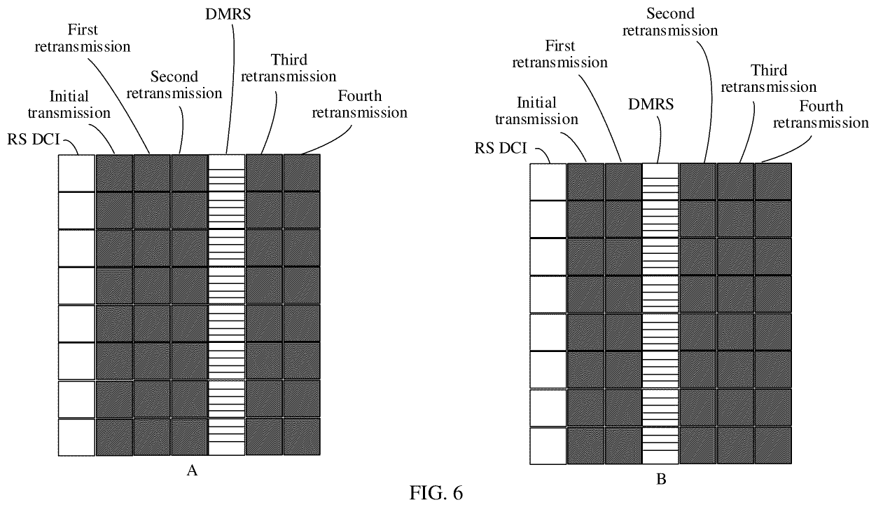

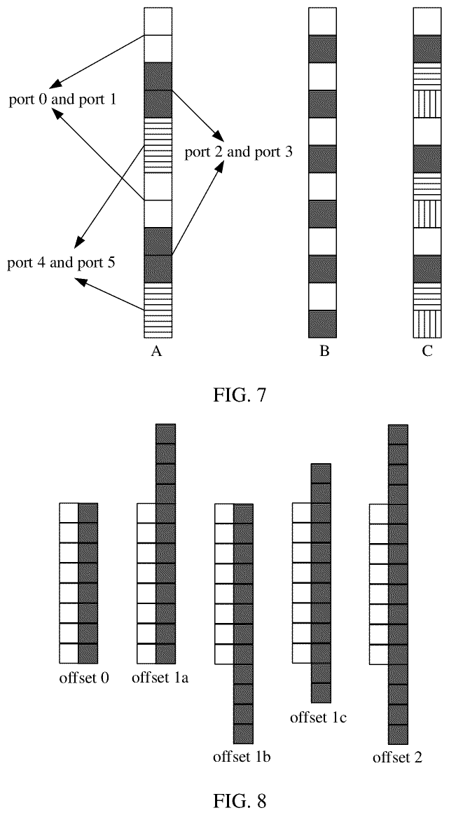

The pattern of the reference signal may indicate content of the reference signal, namely, a time-frequency resource occupied by the reference signal. An RE location of the reference signal may be configured by the first device, or may be obtained by the terminal device by performing blind detection on the received information. For example, for the RE location, refer to FIG. 7. Each type of box represents a type of RE location. As shown in A in FIG. 7, there may be three types of RE locations, including locations corresponding to three types of boxes: an unfilled box, a filled box, and a box with horizontal lines. As shown in B in FIG. 7, there may be two types of RE locations, including locations corresponding to two types of boxes: an unfilled box and a filled box. As shown in C in FIG. 7, there may be four types of RE locations, including locations corresponding to four types of boxes: an unfilled box, a filled box, a box with horizontal lines, and a box with vertical lines.

Optionally, there may be a correspondence between the RE location of the reference signal and a port number. For example, as shown in A in FIG. 7, port 0 and port 1 are related to RE locations corresponding to unfilled boxes, port 2 and port 3 are related to RE locations corresponding to filled boxes, and port 4 and port 5 are related to RE locations corresponding to boxes with horizontal lines.

In embodiments of this application, a sequence may include a pseudo-random sequence, a CAZAC sequence, and the like. This is not limited herein. The pseudo-random sequence may also be referred to as a PN code, and is a regular periodic binary sequence that appears to be random. The pseudo-random sequence may further include a longest linear feedback shift register sequence, an m-sequence for short. The sequence may further include a Gold code sequence proposed and obtained through analysis based on the m-sequence. The Gold code sequence is formed by adding a preferred pair including two m-sequences with a same code length and a same code clock rate by using modulo 2. Autocorrelation of the Gold code sequence is inferior to that of the m-sequence, and cross-correlation of the Gold code sequence is better than that of the m-sequence.

CAZAC sequences are now widely used in the field of pulse radar compression, spread spectrum communication systems (for example, synchronous CDMA and multi-carrier code division multiple access (multi-carrier-CDMA, MC-CDMA)), OFDM systems (for example, LTE and WiMAX), and the like. An amplitude of a CAZAC sequence of any length is constant. After any CAZAC sequence is shifted by n bits, when n is not an integer multiple of a periodicity of the CAZAC sequence, a sequence obtained through the shift is irrelevant to the original sequence. Cross-correlation and partial correlation values of the CAZAC sequence are close to 0. A signal including any CAZAC sequence has a low ratio of a peak value to an average value of the signal, and has a low peak-to-average ratio. Any CAZAC sequence is still a CAZAC sequence after Fourier forward and reverse change. The CAZAC sequence may include a ZC sequence, a Frank sequence, a Golomb polyphase sequence, a Chirp sequence, or the like. This is not limited herein.

In some feasible examples, the sequence parameter may include at least one of a sequence type, a scrambling identifier, a root identifier, a cyclic shift, or the like.

The sequence type may include the foregoing pseudo-random sequence, the CAZAC sequence, and the like, for example, a PN code and a ZC code, and may further include a sequence that is not mentioned in this application. The root identifier may also be referred to as a root sequence index. The root identifier and the cyclic shift are used to generate a preamblesequence of each cell, and may be used to ensure that preamble sequences used by adjacent cells are different.

The scrambling identifier may include one or more of a user identifier (for example, a user number or a UE number), a user group identifier, or a cell identifier. The scrambling identifier may be used to perform interference randomization on the sequence. For example, the sequence of the reference signal is scrambled, so that during blind detection, the terminal device determines, based on the scrambling identifier, whether the reference signal is the reference signal that is of the terminal device and that indicates the scheduling information.

A form of the sequence of the reference signal is not limited in this application. For example, a sequence r(m) of the reference signal indicating the scheduling information may be shown in Formula (1), and an initialization function cᵢₙᵢₜ used to generate a scrambling sequence of the sequence r(m) may be shown in Formula (2):

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) \qquad ( 1 )$$

$${c}_{init} = {2}^{x 1} ( {i}_{UE} + 1 ) ( ⌊ \frac{{N}_{ID}}{y} ⌋ + 1 ) + {2}^{x 2} ( {i}_{UE} + 1 ) + ( {N}_{ID} mod y ) \qquad ( 2 )$$

m is a sequence number, and c(2m) and c(2m+1) are both scrambling sequences. x1, x2 are integers, and y is a positive integer. i_{UE} may be a user number or a user scrambling identifier (which may be referred to as a user identifier for short), and N_{ID} may be a user group identifier or a cell identifier. Values of x1, x2, y are not limited in this application. For example, it is assumed that x1=11, x2=6, and y=4, and the initialization function

$${c}_{init} = {2}^{11} ( {i}_{UE} + 1 ) ( ⌊ \frac{{N}_{ID}}{4} ⌋ + 1 ) + {2}^{6} ( {i}_{UE} + 1 ) + ( {N}_{ID} mod 4 )$$

for generating the scrambling sequence of the sequence r(m) may be obtained according to Formula (2).

For another example, a sequence r^{(p}^{ᵢ}⁾(n, l′) of the reference signal indicating the scheduling information may be shown in Formula (3), and a cyclic shift αᵢ may be shown in Formula (4):

$${r}^{( {p}_{i} )} ( n , {l}^{′} ) = {r}_{u , v}^{( {α}_{i} , δ )} ( n ) \qquad ( 3 )$$

$${α}_{i} = 2 π \frac{{n}_{RS}^{cs , i}}{{n}_{RS}^{cs , max}} \qquad ( 4 )$$

n is a sequence number, and 0≤n≤M_{sc}^{RS}−1. M_{sc}^{RS} is a sequence length, for example, a quantity of occupied subcarriers. l′ is a symbol number, where l′∈{0,1, . . . , N_{symb}^{RS}−1}, and N_{symb}^{RS} is a symbol length. pᵢ is a number of an antenna port for sending the reference signal, u is a sequence group in a root sequence, and v is a sequence number in the root sequence. A cyclic shift n_{RS}^{cs}∈{0,1, . . . , n_{RS}^{cs,max}−1} of the reference signal may be a higher layer parameter, for example, configured by the network device. n_{RS}^{cs,max} is a maximum quantity of cyclic shifts of the reference signal. A formula of n_{RS}^{cs,i} may be shown in Formula (5):

$${n}_{RS}^{cs , i} = \{ \begin{matrix}( {n}_{RS}^{cs} + \frac{{n}_{RS}^{cs , max} ⌊ ( {p}_{i} - 1000 ) / 2 ⌋}{{N}_{ap}^{RS} / 2} ) mod {n}_{RS}^{cs , max} & {N}_{ap}^{RS} = 4 and {n}_{RS}^{cs , max} = 6 \\ ( {n}_{RS}^{cs} + \frac{{n}_{RS}^{cs , max} ( {p}_{i} - 1000 )}{{N}_{ap}^{RS}} ) mod {n}_{RS}^{cs , max} & others\end{matrix} \qquad ( 5 )$$

Nₐₚ^{RS} is a maximum quantity of antenna ports of the reference signal.

A formula of δ may be shown in Formula (6):

$$δ = {log}_{2} ( {K}_{TC} ) \qquad ( 6 )$$

K_{TC} is a quantity of transmission combs, and K_{TC}∈{2,4,8}. K_{TC} may be a higher layer parameter, for example, configured by the network device. For a relationship between K_{TC} and n_{SRS}^{cs,max} refer to Table 2.

TABLE 2

| K_{TC} | n_{SRS}^{cs, max} |
|---|---|
| 2 | 8 |
| 4 | 12 |
| 8 | 6 |

Optionally, the sequence group and the sequence number may be determined based on a scrambling identifier n_{ID}^{RS}. For example, the scrambling identifier n_{ID}^{RS} may be obtained by using Formula (7) below:

$$u = ( {f}_{gh} ( {n}_{s , f}^{μ} , {l}^{′} ) + {n}_{ID}^{RS} ) mod 30 \qquad ( 7 )$$

n_{s,f}^{μ} is a slot number in a frame structure of a subcarrier spacing configuration μ. l′is a symbol number, and f_{gh}(n_{s,f}^{μ}, l′) is sequence group hopping. The network device may configure the sequence group and the sequence number based on whether the terminal device supports sequence group hopping and sequence hopping. Whether the terminal device supports sequence group hopping and sequence hopping may include the following three scenarios. If the terminal device does not support sequence group hopping, f_{gh}(n_{s,f}^{μ}, l′)=0. If the terminal device does not support sequence hopping, v=0.

Scenario 1: If the terminal device does not support sequence group hopping and sequence hopping, sequence group hopping f_{gh}(n_{s,f}^{μ}, l′)=0, and sequence hopping v=0.

Scenario 2: If the terminal device supports sequence group hopping but does not support sequence hopping, sequence group hopping f_{gh}(n_{s,f}^{μ}, l′) may be obtained by using Formula (8) below, and sequence hopping v=0.

$${f}_{gh} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + {l}^{′} ) + m ) \cdot {2}^{m} ) mod 30 \qquad ( 8 )$$

A pseudo-random sequence c(i) may be initialized to Cᵢₙᵢₜ=n_{ID}^{RS}.

Scenario 3: If the terminal device supports sequence hopping but does not support sequence group hopping, sequence group hopping f_{gh}(n_{s,f}^{μ}, l′)=0, and sequence hopping v may be obtained by using Formula (9) below:

$$v = \{ \begin{matrix}c ( {n}_{s , f}^{μ} {N}_{symb}^{slot} + {l}_{0} + {l}^{′} ) & {M}_{sc , b}^{RS} > 6 {N}_{sc}^{RB} \\ 0 & others\end{matrix} \qquad ( 9 )$$

A pseudo-random sequence c(i) may be initialized to cᵢₙᵢₜ=n_{ID}^{RS}. N_{sc}^{RB} is a quantity of subcarriers included in one RB, for example, 12.

Optionally, the sequence is a gold sequence, a length of an input sequence is 31, and a length of an output sequence c(n) is M_{PN}. n=0,1, . . . , M_{PN}−1, and a calculation formula of c(n) is shown in Formula (10):

$$\begin{matrix}c ( n ) = ( {x}_{1} ( n + {N}_{c} ) + {x}_{2} ( n + {N}_{c} ) ) mod 2 \\ {x}_{1} ( n + 31 ) = ( {x}_{1} ( n + 3 ) + {x}_{1} ( n ) ) mod 2 \\ {x}_{2} ( n + 31 ) = ( {x}_{2} ( n + 3 ) + {x}_{2} ( n + 2 ) + {x}_{2} ( n ) ) mod 2\end{matrix} \qquad ( 10 )$$

N_{C}=1600. A 1^{st} m-sequence x₁(n) is initialized as x₁(0)=1, and x₁(n)=0, where n=1, . . . , 30. A 2^{nd} m-sequence x₂(n) is initialized to cᵢₙᵢₜ=Σᵢ₌₀³⁰x₂(i)*2ⁱ.

Optionally, the first device, for example, the network device, may determine the sequence parameter based on a sequence type of the sequence. For example, when the sequence of the reference signal is a PN sequence, the network device may configure a scrambling identifier of the sequence; or when the sequence of the reference signal is a ZC sequence, the network device may configure a root identifier and/or a cyclic shift of the sequence. In this way, the sequence parameter is determined based on the sequence type of the sequence, so that accuracy of determining the sequence parameter can be improved.

Optionally, the reference signal may not indicate the transmission type of the data transmission, in other words, may not indicate whether data whose transmission is performed is uplink data or downlink data, or does not need to indicate whether data whose transmission is performed is sent data or received data.

When the transmission type of the data transmission is not indicated, in some feasible examples, the method further includes: The first device determines the transmission type of the data transmission based on the signal class of the reference signal.

For example, when the reference signal is an SRS, it is determined that the transmission type of the data transmission is uplink transmission, and data whose transmission is performed is sent data; or when the reference signal is a DMRS, it is determined that the transmission type of the data transmission is downlink transmission, and data whose transmission is performed is received data. In this way, in the foregoing examples, the transmission type of the data transmission is determined based on the determined signal class of the reference signal, and then the data transmission is performed.

Optionally, for uplink data transmission, the reference signal is an SRS, and the SRS may be used as a scheduling request (SR) to carry the scheduling information. In addition, for a data transmission requirement with a latency of 0.1 ms, the SRS may be further used as a channel estimation and demodulation reference signal of uplink data, to reduce pilot overheads.

Optionally, different SRS root sequences and/or cyclic shifts may correspond to different scheduling requests. For example, sizes of requested resources may be different, and sizes of data packets whose transmission is to be performed may be different.

In embodiments of this application, that there is a first association relationship between the information about the reference signal and the scheduling information of the data transmission may be understood as that the reference signal implicitly indicates the scheduling information, instead of performing transmission on the reference signal and the scheduling information separately. In comparison with a manner of separately sending the scheduling information, overheads of the scheduling information can be reduced, and complexity and a latency of blind detection can be reduced.

The first association relationship between the information about the reference signal and the scheduling information is not limited in this application. The first association relationship may be predefined in a protocol, or may be notified by the first device to the second device via signaling. The signaling may be included in the reference signal or information other than the reference signal. When the reference signal includes the first association relationship, the first association relationship may be obtained by the second device by performing blind detection on the reference signal.

In some feasible examples, the method further includes: The first device sends configuration information to the second device; and the first device sends the reference signal based on the configuration information. Correspondingly, the second device receives the configuration information from the first device; and the second device receives the reference signal based on the configuration information. The configuration information indicates one or more candidate values of the information about the reference signal, and there is a second association relationship between the candidate value and one or more pieces of scheduling information; or the configuration information indicates a second association relationship, and the second association relationship indicates one or more candidate values of the information about the reference signal. The second association relationship includes the first association relationship.

For example, the configuration information indicates a plurality of candidate values of a quantity of time domain symbols occupied for one single transmission. For example, the plurality of candidate values include 1 and 2, and there is a second association relationship between each of the candidate values and a time-frequency resource for the data transmission. Alternatively, the configuration information may indicate a second association relationship, and the second association relationship indicates a plurality of candidate values of a quantity of time domain symbols occupied for one single transmission. For example, the plurality of candidate values include 1 and 2. When the candidate value is 1, it indicates that the quantity of time domain symbols occupied for the single transmission is 1; or when the candidate value is 2, it indicates that the quantity of time domain symbols occupied for the single transmission is 2.

The candidate value of the information about the reference signal may alternatively be an identifier or a number of the information, or the like. For example, the configuration information may indicate a plurality of identifiers of a frequency domain offset. For example, the plurality of identifiers include 0, 1, and 2, and there is a second association relationship between each of the identifiers and the frequency domain resource for the data transmission. Alternatively, the configuration information may indicate a second association relationship, and the second association relationship indicates a plurality of identifiers of a frequency domain offset. For example, the plurality of identifiers include 0, 1, and 2. When the identifier of the frequency domain offset is 0, refer to offset 0 shown in FIG. 8. It indicates that the frequency domain resource for the data transmission is the same as the frequency domain resource for the reference signal. When the identifier of the frequency domain offset is 1, refer to offset 1a, offset 1b, and offset 1c shown in FIG. 8. It indicates that the frequency domain resource for the data transmission has x more resources than the frequency domain resource for the reference signal. When the identifier of the frequency domain offset is 2, refer to offset 2 in FIG. 8. It indicates that the frequency domain resource for the data transmission has 2× more resources than the frequency domain resource for the reference signal. A unit of the foregoing resource may be an RB or an RBG. For a quantity of RBs, for example, x resources may be four RBs or one RBG, and 2*x resources may be 2*4 RBs or 2*1 RBGs.

A location of the frequency domain offset is not limited in this application. The location of the frequency domain offset may be predefined in a protocol, or may be notified by the network device to the terminal device via signaling. For example, for the frequency domain offset between the data transmission and the reference signal, refer to FIG. 8. As shown by offset 1a in FIG. 8, the frequency domain resource for the data transmission may be located above the frequency domain resource for the reference signal. Alternatively, as shown by offset 1b in FIG. 8, the frequency domain resource for the data transmission may be located below the frequency domain resource for the reference signal. Alternatively, as shown by offset 1c in FIG. 8, the frequency domain resource for the data transmission may be located on two sides of the frequency domain resource for the reference signal. For a case in which the frequency domain resource for the data transmission has 2*x or a larger quantity of more resources than the frequency domain resource for the reference signal, refer to the case in which the frequency domain resource for the data transmission has x more resources than the frequency domain resource for the reference signal in FIG. 8. The frequency domain resource for the data transmission may be located above, below, or on two sides of the frequency domain resource for the reference signal.

A value of the frequency domain offset is not limited in this application. The value of the frequency domain offset may be predefined in a protocol, or may be notified by the network device to the terminal device via signaling. Optionally, the frequency domain offset may be an integer greater than or equal to 0 and less than or equal to 4. For example, it is assumed that the frequency domain resource for the reference signal is x1 to y1. When the frequency domain resource for the data transmission has x more resources than the frequency domain resource for the reference signal, the frequency domain resource for the data transmission may be x1−x to y1, x1−x/2 to y+x/2, or x1 to y+x. When the frequency domain resource for the data transmission has 2*x more resources than the frequency domain resource for the reference signal, the frequency domain resource for the data transmission may be x1−2x to y1, x1−x to y+x, or x1 to y+2x.

It may be understood that the configuration information explicitly or implicitly carries the candidate value of the information about the reference signal. In this example, the reference signal is received based on the candidate value in the configuration information, and the second association relationship is obtained. In this way, in a process in which the second device performs blind detection on the reference signal, the value of the information about the reference signal can be obtained, thereby improving blind detection efficiency and accuracy.

Optionally, there is an association relationship between one piece of information about the reference signal and one piece of scheduling information, or there is an association relationship between one piece of information about the reference signal and a plurality of pieces of scheduling information, or there is an association relationship between a plurality of pieces of information about the reference signal and one piece of scheduling information. The first association relationship may be one or more of the foregoing association relationships. Content of the first association relationship is not limited in this application. Refer to the following examples.

It should be understood that the methods in embodiments of this application may be used independently or in combination with each other. For example, the first association relationship and the information about the reference signal may be used to determine the scheduling information, or one piece of scheduling information may be used to determine another piece of scheduling information. In addition, a method for determining scheduling information may change with evolution of the technical solutions. The technical solutions provided in this application are not limited to processes described below. Moreover, descriptions of scenarios in embodiments of this application are merely examples, and the solutions in embodiments of this application are not limited to being applicable to only the described scenarios, and are also applicable to a scenario in which a similar problem exists.

The following first describes the first association relationship between one piece of information about the reference signal and one piece of scheduling information.

In some feasible examples, the first association relationship may be a correspondence between a time-frequency resource for the reference signal and a time-frequency resource for the data transmission in the scheduling information. In this way, the time-frequency resource for the data transmission can be determined based on the first association relationship between the time-frequency resource for the reference signal and the time-frequency resource for the data transmission in the scheduling information.

For example, the first device may configure the time-frequency resource for the reference signal and the time-frequency resource for the data transmission. Alternatively, the first device may configure a frequency domain offset between a frequency domain resource for the data transmission and a frequency domain resource for the reference signal, a time domain offset between a time domain resource for the data transmission and a time domain resource for the reference signal, and/or the like.

The time domain offset and the frequency domain offset may be notified by the first device to the second device via signaling, or may be obtained by the second device through blind detection, or may be predefined in a protocol. A configured time domain resource and/or frequency domain resource may include one or more of a configured CORESET, an aggregation level of DCI, a quantity of resource blocks (RBs) corresponding to the aggregation level, or the like.

For example, an aggregation level 1 corresponds to n RBs, and an aggregation level 2 corresponds to 2n RBs, where n is a positive integer. A value of n is not limited in this application. n may be 6, that is, the aggregation level 1 corresponds to six RBs, the aggregation level 2 corresponds to 12 RBs, and so on.

In some feasible examples, a time-frequency resource for the data transmission and a time-frequency resource for the reference signal meet at least one of the following: the frequency domain resource for the data transmission is the same as the frequency domain resource for the reference signal; the information about the reference signal indicates that there is a frequency domain offset between the frequency domain resource for the data transmission and the frequency domain resource for the reference signal; the time domain resource for the data transmission is the same as the time domain resource for the reference signal; or the information about the reference signal indicates that there is a time domain offset between the time domain resource for the data transmission and the time domain resource for the reference signal.

In this example, the first association relationship may be an association relationship between the time-frequency resource for the reference signal and the time-frequency resource for the data transmission. The time domain resource for the reference signal may be the same as or different from the time domain resource for the data transmission, and the frequency domain resource for the reference signal may be the same as or different from the frequency domain resource for the data transmission.

Values of the time domain offset and the frequency domain offset are not limited in this application. For example, a quantity of resource blocks of the frequency domain offset may be f₁, where f₁ is an integer. Optionally, f₁ may be an integer greater than or equal to 0 and less than or equal to 4. For another example, if a number of a symbol in which the reference signal is located is l₁, a quantity of resource blocks of the time domain offset may be r₁. For example, the time domain resource for the data transmission may be in a symbol following the time domain resource for the reference signal, and a symbol number of the time domain resource for the data transmission may be l₁+r₁, where r₁ is an integer. Optionally, r₁ may be an integer greater than or equal to 0 and less than or equal to 4. If the time domain offset is 0 or there is no time domain offset, it indicates that the same time domain resource is used for the reference signal and the data transmission. If the frequency domain offset is 0 or there is no frequency domain offset, it indicates that the same frequency domain resource is used for the reference signal and the data transmission.

In a possible implementation, the frequency domain resource for the reference signal is the same as the frequency domain resource for the data transmission, and the time domain resource for the reference signal is the same as the time domain resource for the data transmission.

In a possible implementation, the frequency domain resource for the reference signal is the same as the frequency domain resource for the data transmission, and there is a time domain offset r₁ between the time domain resource for the reference signal and the time domain resource for the data transmission.

In a possible implementation, there is a frequency domain offset f₁ between the frequency domain resource for the reference signal and the frequency domain resource for the data transmission, and the time domain resource for the reference signal is the same as the time domain resource for the data transmission.

In a possible implementation, there is a frequency domain offset f₁ between the frequency domain resource for the reference signal and the frequency domain resource for the data transmission, and there is a time domain offset r₁ between the time domain resource for the reference signal and the time domain resource for the data transmission.

Optionally, when one single data transmission occupies one symbol, a value of r₁ may be a repetition quantity. When the single data transmission occupies d symbols, the value of r₁ may be d*the repetition quantity.

It may be understood that the time domain resource for the data transmission may be related to a quantity of symbols for one single data transmission and a repetition quantity, so that the time domain resource for the data transmission can be flexibly determined based on the quantity of symbols for the single data transmission and the repetition quantity, improving communication performance.

In some feasible examples, the first association relationship may be a correspondence between the RE location of the reference signal and the scheduling information. In this way, the scheduling information of the data transmission can be determined based on the RE location of the reference signal and the first association relationship between the RE location of the reference signal and the scheduling information.

Optionally, the first association relationship is a correspondence between the RE location of the reference signal and the frequency domain offset, in the scheduling information, between the frequency domain resource for the data transmission and the frequency domain resource for the reference signal.

For example, a first RE location corresponds to a first frequency domain offset, a second RE location corresponds to a second frequency domain offset, and a third RE location corresponds to a third frequency domain offset. In this way, the frequency domain offset between the reference signal and the data transmission can be determined based on the RE location and the first association relationship between the RE location and the frequency domain offset in the scheduling information.

In embodiments of this application, values of the first frequency domain offset, the second frequency domain offset, and the third frequency domain offset, and the like may be predefined in a protocol, or may be notified by the first device to the second device via signaling. This is not limited in embodiments of this application. For example, the first frequency domain offset is 0, the second frequency domain offset is 1, and the third frequency domain offset is 2.

Optionally, the first device may configure a plurality of candidate values of the frequency domain offset, and there may be a correspondence between each candidate value and at least one RE location of the reference signal. Refer to the descriptions in FIG. 8. Details are not described herein again.

Optionally, the first association relationship is a correspondence between the port number of the reference signal and the frequency domain offset, in the scheduling information, between the frequency domain resources.

For example, a first port number corresponds to the first frequency domain offset, a second port number corresponds to the second frequency domain offset, and a third port number corresponds to the third frequency domain offset. For another example, port 0 and/or port 1 correspond/corresponds to the first frequency domain offset, port 2 and/or port 3 correspond/corresponds to the second frequency domain offset, and port 4 and/or port 5 correspond/corresponds to the third frequency domain offset. In this way, after the port number of the reference signal is determined, the frequency domain offset between the reference signal and the data transmission can be determined based on the port number of the reference signal and the first association relationship between the port number of the reference signal and the frequency domain offset, in the scheduling information, between the frequency domain resources.

Optionally, the first device may configure a plurality of candidate values of the frequency domain offset, and there may be a correspondence between each candidate value and at least one port number of the reference signal.

In some feasible examples, the time domain resource for the data transmission includes a quantity of time domain symbols occupied for one single data transmission, and the information about the reference signal indicates the quantity of time domain symbols.

The quantity of time domain symbols occupied for the single data transmission may be 1, 2, or the like. This is not limited herein. Optionally, the quantity of time domain symbols is predefined in a protocol, or may be notified by the first device to the second device via signaling. For example, the first device may configure a plurality of candidate values of the quantity of time domain symbols occupied for the single data transmission, and there is a correspondence between the RE location of the reference signal and the plurality of candidate values of the quantity of time domain symbols.

Optionally, the first association relationship is a correspondence between the RE location of the reference signal and the quantity, in the scheduling information, of time domain symbols occupied for the single data transmission.

For example, the plurality of candidate values of the quantity of time domain symbols occupied for the single data transmission include 1 and 2. When the RE location is location 1, it indicates that the quantity of time domain symbols occupied for the single data transmission is 1; or when the RE location is location 2, it indicates that the quantity of time domain symbols occupied for the single data transmission is 2. In this way, the quantity of time domain symbols occupied for the single data transmission can be determined based on the RE location of the reference signal.

Optionally, the first association relationship is a correspondence between the port number of the reference signal and the quantity, in the scheduling information, of time domain symbols occupied for the single data transmission.

For example, the plurality of candidate values of the quantity of time domain symbols occupied for the single data transmission include 1 and 2. When the port number is port 0 and/or port 1, it indicates that the quantity of time domain symbols occupied for the single data transmission is 1; or when the port number is port 2 and/or port 3, it indicates that the quantity of time domain symbols occupied for the single data transmission is 2. In this way, the quantity of time domain symbols occupied for the single data transmission can be determined based on the port number of the reference signal.

The quantity of time domain symbols occupied for the single data transmission may be predefined in a protocol, or may be notified by the first device to the second device via signaling. This is not limited in this application.

Optionally, the first device may configure the plurality of candidate values of the quantity of time domain symbols occupied for the single data transmission, and there may be a correspondence between each candidate value and at least one RE location of the reference signal. Alternatively, the first device may configure the plurality of candidate values of the quantity of time domain symbols occupied for the single data transmission, and there may be a correspondence between each candidate value and the port number of the reference signal.

In some other feasible examples, the first association relationship may be a correspondence between the sequence parameter of the reference signal and the scheduling information. In this way, the scheduling information can be determined based on the sequence parameter of the reference signal and the first association relationship between the sequence parameter of the reference signal and the scheduling information.

Content of the sequence parameter of the reference signal is not limited in this application. Optionally, there is a correspondence between the scrambling identifier of the sequence of the reference signal and the RE location of the reference signal. The RE location corresponding to the scrambling identifier may be predefined in a protocol, or may be notified by the first device to the second device via signaling. This is not limited in this application.

For example, a user group identifier is the scrambling identifier. The user group identifier configured by a base station includes a first number, a second number, and a third number. As shown in A in FIG. 7, there may be a correspondence between the first number and an RE location corresponding to an unfilled box, there may be a correspondence between the second number and an RE location corresponding to a filled box, and there may be a correspondence between the third number and an RE location corresponding to a box with horizontal lines. In this way, the second device may determine the RE location based on the scrambling identifier of the reference signal and the correspondence between the scrambling identifier of the reference signal and the RE location of the reference signal.

Optionally, the first device configures a UE number of the second device in one CORESET. The UE number may be used for sequence scrambling of the reference signal, so that the second device determines, through blind detection, whether the reference signal is a reference signal of the second device.

For a scrambling manner, refer to the foregoing descriptions. For example, a UE number configured by the base station is i_{UE}=0,1,2, . . . , 7, a sequence of the reference signal (for example, an RS DCI) may be scrambled by using i_{UE}, and an initial value of the sequence may be determined based on

$${c}_{init} = {2}^{11} ( {i}_{UE} + 1 ) ( ⌊ \frac{{N}_{ID}}{4} ⌋ + 1 ) + {2}^{6} ( {i}_{UE} + 1 ) + ( {N}_{ID} mod 4 ) .$$

In this way, the UE number of the second device is configured in one CORESET. This can reduce signaling overheads and help improve efficiency of detecting the scheduling information.

Optionally, the first device configures N_{ID} as the scrambling identifier. In this way, efficiency of detecting the scheduling information can be improved.

Optionally, the reference signal includes a DMRS, the first device may configure one or more scrambling identifiers for one second device, and there may be a correspondence between each of the scrambling identifiers and the scheduling information.

For example, the base station configures four scrambling identifiers for the terminal, and each scrambling identifier may indicate a different value of scheduling information, to indicate different scheduling information. This can reduce signaling overheads and help improve efficiency of detecting the scheduling information.

Optionally, the first device configures one or more scrambling identifiers for different second devices.

For example, a user number i_{UE}=0,1,2 is configured for UE 1, a user number i_{UE}=3,4,5 is configured for UE 2, and a user number i_{UE}=6,7 is configured for UE 3. In this way, signaling overheads can be reduced, and efficiency of detecting the scheduling information can be improved.

The following first uses an example in which the scheduling information is the frequency domain offset between the reference signal and the data transmission, and the sequence parameter includes one of the following of the sequence: the scrambling identifier, the root sequence, or the cyclic shift. The scrambling identifier, the root sequence, and the cyclic shift that are of the sequence may be determined based on a sequence type. For a method for determining the scheduling information by using a plurality of sequence parameters, refer to the descriptions of determining the scheduling information by using one sequence parameter. The time domain offset, in the scheduling information, between the time domain resource for the data transmission and the time domain resource for the reference signal may be determined based on the sequence parameter of the reference signal. For details, refer to the descriptions of the method for determining the frequency domain offset between the frequency domain resource for the data transmission and the time domain resource for the reference signal.

Optionally, the first association relationship is a correspondence between the scrambling identifier of the sequence of the reference signal and the frequency domain offset.

For example, a first scrambling identifier corresponds to the first frequency domain offset, a second scrambling identifier corresponds to the second frequency domain offset, and a third scrambling identifier corresponds to the third frequency domain offset. In this way, the frequency domain offset can be determined based on the scrambling identifier of the sequence of the reference signal and the correspondence between the scrambling identifier of the sequence of the reference signal and the frequency domain offset between the reference signal and the data transmission.

Optionally, the first association relationship is a correspondence between the root sequence of the sequence of the reference signal and the frequency domain offset.

For example, a first root sequence corresponds to the first frequency domain offset, a second root sequence corresponds to the second frequency domain offset, and a third root sequence corresponds to the third frequency domain offset. In this way, the frequency domain offset can be determined based on the root sequence of the sequence of the reference signal and the correspondence between the root sequence of the sequence of the reference signal and the frequency domain offset between the reference signal and the data transmission.

Optionally, the first association relationship is a correspondence between the cyclic shift of the sequence of the reference signal and the frequency domain offset.

For example, a first cyclic shift corresponds to the first frequency domain offset, a second cyclic shift corresponds to the second frequency domain offset, and a third cyclic shift corresponds to the third frequency domain offset. In this way, the frequency domain offset can be determined based on the cyclic shift of the sequence of the reference signal and the correspondence between the cyclic shift of the sequence of the reference signal and the frequency domain offset between the reference signal and the data transmission.

Optionally, the first device may configure a plurality of candidate values of the frequency domain offset, and there may be a correspondence between each candidate value and at least one sequence parameter of the reference signal.

It should be understood that the foregoing descriptions are examples of the first association relationship between the information about the reference signal and the time-frequency resource in the scheduling information. Actually, another first association relationship or another manner of determining the time-frequency resource may be further included. This is not limited herein.

The following describes a first association relationship between the information about the reference signal and the modulation scheme of the data transmission in the scheduling information, a first association relationship between the information about the reference signal and the code rate of the data transmission in the scheduling information, and a first association relationship between the information about the reference signal and an MCS identifier of the data transmission in the scheduling information. It should be understood that the MCS includes information about the modulation scheme and information about coding.

In a possible implementation, the first association relationship includes at least one of the following: a correspondence between the RE location of the reference signal and the modulation scheme of the data transmission in the scheduling information; a correspondence between the RE location of the reference signal and the code rate of the data transmission in the scheduling information; or a correspondence between the RE location of the reference signal and the MCS identifier of the data transmission in the scheduling information.

For example, the first RE location corresponds to a first modulation scheme, the second RE location corresponds to a second modulation scheme, and the third RE location corresponds to a third modulation scheme. In this way, the modulation scheme of the data transmission can be determined based on the RE location of the reference signal and the first association relationship between the RE location of the reference signal and the modulation scheme of the data transmission in the scheduling information.

For example, the first RE location corresponds to a first code rate, the second RE location corresponds to a second code rate, and the third RE location corresponds to a third code rate. In this way, the code rate of the data transmission can be determined based on the RE location of the reference signal and the first association relationship between the RE location of the reference signal and the code rate of the data transmission in the scheduling information.

For example, the first RE location corresponds to a first MCS identifier, the second RE location corresponds to a second MCS identifier, and the third RE location corresponds to a third MCS identifier. In this way, the MCS identifier of the data transmission can be determined based on the RE location of the reference signal and the first association relationship between the RE location of the reference signal and the MCS identifier of the data transmission in the scheduling information.

In a possible implementation, the first association relationship includes at least one of the following: a correspondence between the port number of the reference signal and the modulation scheme of the data transmission in the scheduling information; a correspondence between the port number of the reference signal and the code rate of the data transmission in the scheduling information; or a correspondence between the port number of the reference signal and the MCS identifier of the data transmission in the scheduling information.

For example, the first port number corresponds to the first modulation scheme, the second port number corresponds to the second modulation scheme, and the third port number corresponds to the third modulation scheme. For another example, port 0 and/or port 1 correspond/corresponds to the first modulation scheme, port 2 and/or port 3 correspond/corresponds to the second modulation scheme, and port 4 and/or port 5 correspond/corresponds to the third modulation scheme. In this way, the modulation scheme of the data transmission can be determined based on the port number of the reference signal and the first association relationship between the port number of the reference signal and the modulation scheme of the data transmission in the scheduling information.

For example, the first port number corresponds to the first code rate, the second port number corresponds to the second code rate, and the third corresponds to the third code rate. For another example, port 0 and/or port 1 correspond/corresponds to the first code rate, port 2 and/or port 3 correspond/corresponds to the second code rate, and port 4 and/or port 5 correspond/corresponds to the third code rate. In this way, the code rate of the data transmission can be determined based on the port number of the reference signal and the first association relationship between the port number of the reference signal and the code rate of the data transmission in the scheduling information.

For example, the first port number corresponds to the first MCS identifier, the second port number corresponds to the second MCS identifier, and the third port number corresponds to the third MCS identifier. For another example, port 0 and/or port 1 correspond/corresponds to the first MCS identifier, port 2 and/or port 3 correspond/corresponds to the second MCS identifier, and port 4 and/or port 5 correspond/corresponds to the third MCS identifier. In this way, the MCS identifier of the data transmission can be determined based on the port number of the reference signal and the first association relationship between the port number of the reference signal and the MCS identifier of the data transmission in the scheduling information.

In a possible implementation, the first association relationship includes at least one of the following: the first association relationship is a correspondence between the scrambling identifier of the sequence of the reference signal and the modulation scheme of the data transmission in the scheduling information; a correspondence between the scrambling identifier of the sequence of the reference signal and the code rate of the data transmission in the scheduling information; or a correspondence between the scrambling identifier of the sequence of the reference signal and the MCS identifier of the data transmission in the scheduling information.

For example, the first scrambling identifier corresponds to the first modulation scheme, the second scrambling identifier corresponds to the second modulation scheme, and the third scrambling identifier corresponds to the third modulation scheme. In this way, the modulation scheme of the data transmission can be determined based on the scrambling identifier of the sequence of the reference signal and the first association relationship between the scrambling identifier of the sequence of the reference signal and the modulation scheme of the data transmission in the scheduling information.

For example, the first scrambling identifier corresponds to the first code rate, the second scrambling identifier corresponds to the second code rate, and the third scrambling identifier corresponds to the third code rate. In this way, the code rate of the data transmission can be determined based on the scrambling identifier of the sequence of the reference signal and the first association relationship between the scrambling identifier of the sequence of the reference signal and the code rate of the data transmission in the scheduling information.

For example, the first scrambling identifier corresponds to the first MCS identifier, the second scrambling identifier corresponds to the second MCS identifier, and the third scrambling identifier corresponds to the third MCS identifier. In this way, the MCS identifier of the data transmission can be determined based on the scrambling identifier of the sequence of the reference signal and the first association relationship between the scrambling identifier of the sequence of the reference signal and the MCS identifier of the data transmission in the scheduling information.

In a possible implementation, the first association relationship includes at least one of the following: a correspondence between the root sequence of the sequence of the reference signal and the modulation scheme of the data transmission in the scheduling information; a correspondence between the root sequence of the sequence of the reference signal and the code rate of the data transmission in the scheduling information; or a correspondence between the root sequence of the sequence of the reference signal and the MCS identifier of the data transmission in the scheduling information.

For example, the first root sequence corresponds to the first modulation scheme, the second root sequence corresponds to the second modulation scheme, and the third root sequence corresponds to the third modulation scheme. In this way, the modulation scheme of the data transmission can be determined based on the root sequence of the sequence of the reference signal and the first association relationship between the root sequence of the sequence of the reference signal and the modulation scheme of the data transmission in the scheduling information.

For example, the first root sequence corresponds to the first code rate, the second root sequence corresponds to the second code rate, and the third root sequence corresponds to the third code rate. In this way, the code rate of the data transmission can be determined based on the root sequence of the sequence of the reference signal and the first association relationship between the root sequence of the sequence of the reference signal and the code rate of the data transmission in the scheduling information.

For example, the first root sequence corresponds to the first MCS identifier, the second root sequence corresponds to the second MCS identifier, and the third root sequence corresponds to the third MCS identifier. In this way, the MCS identifier of the data transmission can be determined based on the root sequence of the sequence of the reference signal and the first association relationship between the root sequence of the sequence of the reference signal and the code rate of the data transmission in the scheduling information.

In a possible implementation, the first association relationship includes at least one of the following: a correspondence between the cyclic shift of the sequence of the reference signal and the modulation scheme of the data transmission in the scheduling information; a correspondence between the cyclic shift of the sequence of the reference signal and the code rate of the data transmission in the scheduling information; or a correspondence between the cyclic shift of the sequence of the reference signal and the MCS identifier of the data transmission in the scheduling information.

For example, the first cyclic shift corresponds to the first modulation scheme, the second cyclic shift corresponds to the second modulation scheme, and the third cyclic shift corresponds to the third modulation scheme. In this way, the modulation scheme of the data transmission can be determined based on the cyclic shift of the sequence of the reference signal and the first association relationship between the cyclic shift of the sequence of the reference signal and the modulation scheme of the data transmission in the scheduling information.

For example, the first cyclic shift corresponds to the first code rate, the second cyclic shift corresponds to the second code rate, and the third cyclic shift corresponds to the third code rate. In this way, the modulation scheme of the data transmission can be determined based on the code rate of the sequence of the reference signal and the first association relationship between the code rate of the sequence of the reference signal and the modulation scheme of the data transmission in the scheduling information.

For example, the first cyclic shift corresponds to the first MCS identifier, the second cyclic shift corresponds to the second MCS identifier, and the third cyclic shift corresponds to the third MCS identifier. In this way, the MCS identifier of the data transmission can be determined based on the cyclic shift of the sequence of the reference signal and the first association relationship between the cyclic shift of the sequence of the reference signal and the MCS identifier of the data transmission in the scheduling information.

The first modulation scheme, the second modulation scheme, the third modulation scheme, and the like may be predefined in a protocol, or may be notified by the first device to the second device via signaling. This is not limited in embodiments of this application. For example, the first modulation scheme is QPSK, the second modulation scheme is 16 QAM, and the third modulation scheme is 64 QAM.

Optionally, the first device may configure a plurality of candidate values of the modulation scheme, and there is a correspondence between each candidate value and at least one of the following information about the reference signal: the RE location, the port number, the sequence parameter, or the like.

The first code rate, the second code rate, the third code rate, and the like may be predefined in a protocol, or may be notified by the first device to the second device via signaling. This is not limited in embodiments of this application. For example, the first code rate is ¼, the second code rate is ½, and the third code rate is ¾.

Optionally, the first device may configure a plurality of candidate values of the code rate, and there is a correspondence between each candidate value and at least one of the following information about the reference signal: an RE location, the port number, the sequence parameter, or the like.

The first MCS identifier, the second MCS identifier, the third MCS identifier, and the like may be predefined in a protocol, or may be notified by the first device to the second device via signaling. This is not limited in embodiments of this application. A first MCS may be a corresponding modulation scheme and a corresponding code rate when the MCS identifier is 0, a second MCS may be a corresponding modulation scheme and a corresponding code rate when the MCS identifier is 1, and a third MCS may be a corresponding modulation scheme and a corresponding code rate when the MCS identifier is 2. In addition, the modulation scheme and the code rate that correspond to the MCS identifier are not limited in this application. For details, refer to Table 3 and Table 4.

TABLE 3

| MCS identifier | Modulation scheme | Target code rate R [R*1024] |
|---|---|---|
| 0 | 2 | 30 |
| 1 | 2 | 40 |
| 2 | 2 | 50 |

TABLE 4

| MCS identifier | Modulation scheme | Target code rate R [R*1024] |
|---|---|---|
| 0 | 2 | 30 |
| 1 | 4 | 340 |
| 2 | 6 | 438 |

Optionally, the first device may configure a plurality of candidate values of the MCS identifier, and there is a correspondence between each candidate value and at least one of the following information about the reference signal: the RE location, the port number, the sequence parameter, or the like.

It should be understood that the foregoing descriptions are examples of the first association relationship between the information about the reference signal and one of the modulation scheme, the code rate, or the MCS identifier of the data transmission in the scheduling information. Actually, another first association relationship or another manner of determining at least one of the modulation scheme, the code rate, and the MCS identifier of the data transmission may be further included. This is not limited herein.

In a possible implementation, the method for determining the modulation scheme and/or the code rate by the second device may further include: determining the modulation scheme and/or the code rate based on a service type.

The service type may include URLLC, enhanced mobile broadband (eMBB), massive internet of things communication, massive machine type communication (mMTC), or the like. This is not limited herein.

Optionally, there is a correspondence between the service type and the modulation scheme and/or the code rate. For example, an example in which the modulation scheme is the modulation scheme corresponding to the MCS identifier, and the code rate is the code rate corresponding to the MCS identifier is used for description. When there is a correspondence between a first service type and the first MCS identifier, it may be determined, based on the first MCS identifier corresponding to the first service type, that the modulation scheme of the data transmission is the modulation scheme corresponding to the first MCS identifier, and that the code rate of the data transmission is the code rate corresponding to the first MCS identifier. For example, an MCS identifier corresponding to a URLLC service is 0, an MCS identifier corresponding to an eMBB service is 4, and an MCS identifier corresponding to an mMTC service is 2.

The correspondence between the service type and the modulation scheme is not limited in this application. The modulation scheme may be related to spectral efficiency and a code rate. Optionally, the second device determines, based on spectral efficiency and/or a code rate required for the service type, a modulation scheme that meets a requirement, and then determines a code rate corresponding to the modulation scheme. It may be understood that determining the modulationmanner and/or the code rate based on the service type can improve efficiency of service data transmission, and help improve communication performance.

In a possible implementation, the method for determining the modulation scheme and/or the code rate by the second device may further include: determining the modulation scheme and/or the code rate based on configuration information.

The configuration information may be signaling used for configuration, for example, higher layer signaling or physical layer signaling. A configuration manner of the configuration information may further include semi-static configuration, static configuration, dynamic configuration, and the like. In this embodiment of this application, the second device may determine the modulation scheme based on the configuration information. For example, the network device notifies, in a higher-layer semi-static configuration manner, the terminal that the MCS identifier that may be used for the data transmission may be 0, 1, or the like. It may be understood that determining the modulation manner and/or the code rate based on the configuration information can improve accuracy of data channel estimation and demodulation, and help improve communication performance.

The following describes a first association relationship between the information about the reference signal and the transmission configuration indication of the data transmission in the scheduling information.

In a possible implementation, the first association relationship is a correspondence between the RE location of the reference signal and the transmission configuration indication of the data transmission in the scheduling information.

For example, the first RE location corresponds to a first TCI, the second RE location corresponds to a second TCI, and the third RE location corresponds to a third TCI. In this way, the TCI of the data transmission can be determined based on the RE location of the reference signal and the first association relationship between the RE location of the reference signal and the TCI in the scheduling information.

In a possible implementation, the first association relationship is a correspondence between the port number of the reference signal and the transmission configuration indication of the data transmission in the scheduling information.

For example, the first port number corresponds to the first TCI, the second port number corresponds to the second TCI, and the third port number corresponds to the third TCI. For another example, port 0 and/or port 1 correspond/corresponds to the first TCI, port 2 and/or port 3 correspond/corresponds to the second TCI, and port 4 and/or port 5 correspond/corresponds to the third TCI. In this way, the TCI of the data transmission can be determined based on the port number of the reference signal and the first association relationship between the port number of the reference signal and the TCI in the scheduling information.

In a possible implementation, the first association relationship is a correspondence between the scrambling identifier of the sequence of the reference signal and the transmission configuration indication of the data transmission in the scheduling information.

For example, the first scrambling identifier corresponds to the first TCI, the second scrambling identifier corresponds to the second TCI, and the third scrambling identifier corresponds to the third TCI. In this way, the TCI of the data transmission can be determined based on the scrambling identifier of the sequence of the reference signal and the first association relationship between the scrambling identifier of the sequence of the reference signal and the TCI in the scheduling information.

In a possible implementation, the first association relationship is a correspondence between the root sequence of the sequence of the reference signal and the transmission configuration indication of the data transmission in the scheduling information.

For example, the first root sequence corresponds to the first TCI, the second root sequence corresponds to the second TCI, and the third root sequence corresponds to the third TCI. In this way, the TCI of the data transmission can be determined based on the root sequence of the sequence of the reference signal and the first association relationship between the root sequence of the sequence of the reference signal and the transmission configuration indication of the data transmission in the scheduling information.

In a possible implementation, the first association relationship is a correspondence between the cyclic shift of the sequence of the reference signal and the transmission configuration indication of the data transmission in the scheduling information.

For example, the first cyclic shift corresponds to the first TCI, the second cyclic shift corresponds to the second TCI, and the third cyclic shift corresponds to the third TCI. In this way, the TCI of the data transmission can be determined based on the cyclic shift of the sequence of the reference signal and the first association relationship between the cyclic shift of the sequence of the reference signal and the transmission configuration indication of the data transmission in the scheduling information.

The first TCI, the second TCI, the third TCI, and the like may be predefined in a protocol, or may be notified by the first device to the second device via signaling. This is not limited in embodiments of this application. For example, the first TCI indicates that the TCI of the data transmission is the same as the TCI of the reference signal, and the second TCI indicates that the TCI of the data transmission is different from the TCI of the reference signal. For another example, the first TCI indicates that the TCI of the data transmission is the same as a TCI of a first reference signal, and the second TCI indicates that the TCI of the data transmission is the same as a TCI of a second reference signal.

In a possible implementation, the first device configures a plurality of candidate values of the TCI, and there is a correspondence between each candidate value and at least one of the following information about the reference signal: the RE location, the port number, the sequence parameter, or the like.

It should be understood that the foregoing descriptions are examples of the first association relationship between the information about the reference signal and the transmission configuration indication of the data transmission in the scheduling information. Actually, another first association relationship or another manner of determining the transmission configuration indication of the data transmission may be further included. This is not limited herein.

The following describes a first association relationship between the information about the reference signal and the repetition quantity of the data transmission in the scheduling information.

In a possible implementation, the first association relationship is a correspondence between the RE location of the reference signal and the repetition quantity of the data transmission in the scheduling information.

For example, the first RE location corresponds to a first repetition quantity, the second RE location corresponds to a second repetition quantity, and the third RE location corresponds to a third repetition quantity. In this way, the repetition quantity of the data transmission can be determined based on the RE location of the reference signal and the first association relationship between the RE location of the reference signal and the repetition quantity of the data transmission in the scheduling information.

In a possible implementation, the first association relationship is a correspondence between the port number of the reference signal and the repetition quantity of the data transmission in the scheduling information.

For example, the first port number corresponds to the first repetition quantity, the second port number corresponds to the second repetition quantity, and the third port number corresponds to the third repetition quantity. For another example, port 0 and/or port 1 correspond/corresponds to the first repetition quantity, port 2 and/or port 3 correspond/corresponds to the second repetition quantity, and port 4 and/or port 5 correspond/corresponds to the third repetition quantity. In this way, the repetition quantity of the data transmission can be determined based on the port number of the reference signal and the first association relationship between the port number of the reference signal and the repetition quantity of the data transmission in the scheduling information.

In a possible implementation, the first association relationship is a correspondence between the scrambling identifier of the sequence of the reference signal and the repetition quantity of the data transmission in the scheduling information.

For example, the first scrambling identifier corresponds to the first repetition quantity, the second scrambling identifier corresponds to the second repetition quantity, and the third scrambling identifier corresponds to the third repetition quantity. In this way, the repetition quantity of the data transmission can be determined based on the scrambling identifier of the sequence of the reference signal and the first association relationship between the scrambling identifier of the sequence of the reference signal and the repetition quantity in the scheduling information.

In a possible implementation, the first association relationship is a correspondence between the root sequence of the sequence of the reference signal and the repetition quantity of the data transmission in the scheduling information.

For example, the first root sequence corresponds to the first repetition quantity, the second root sequence corresponds to the second repetition quantity, and the third root sequence corresponds to the third repetition quantity. In this way, the repetition quantity of the data transmission can be determined based on the root sequence of the sequence of the reference signal and the first association relationship between the root sequence of the sequence of the reference signal and the repetition quantity of the data transmission in the scheduling information.

In a possible implementation, the first association relationship is a correspondence between the cyclic shift of the sequence of the reference signal and the repetition quantity of the data transmission in the scheduling information.

For example, the first cyclic shift corresponds to the first repetition quantity, the second cyclic shift corresponds to the second repetition quantity, and the third cyclic shift corresponds to the third repetition quantity. In this way, the repetition quantity of the data transmission can be determined based on the cyclic shift of the sequence of the reference signal and the first association relationship between the cyclic shift of the sequence of the reference signal and the repetition quantity of the data transmission in the scheduling information.

Meanings of the first repetition quantity, the second repetition quantity, the third repetition quantity, and the like may be predefined in a protocol, or may be notified by the first device to the second device via signaling. This is not limited in embodiments of this application. For example, the first repetition quantity may be a quantity of repeated transmissions. For example, the first repetition quantity is 0, indicating one initial data transmission; the second repetition quantity is 2, indicating one initial data transmission and two retransmissions; and the third repetition quantity is 3, indicating one initial data transmission and three retransmissions. Alternatively, the first repetition quantity is a quantity of data transmissions. For example, the first repetition quantity is 1, indicating one initial data transmission; the second repetition quantity is 2, indicating one initial data transmission and one retransmission; and the third repetition quantity is 3, indicating one initial data transmission and two retransmissions. Alternatively, the first repetition quantity may be a repetition quantity identifier or an identifier. For example, the first repetition quantity being 0 may indicate one initial data transmission; the second repetition quantity being 1 may indicate one initial data transmission and three retransmissions; and the third repetition quantity being 2 may indicate one initial data transmission and two retransmissions.

Optionally, the first device may configure a plurality of candidate values of the repetition quantity, and there is a correspondence between each candidate value and at least one of the following information about the reference signal: the RE location, the port number, the sequence parameter, or the like.

It should be understood that the foregoing descriptions are examples of the first association relationship between the information about the reference signal and the repetition quantity of the data transmission in the scheduling information. Actually, another first association relationship or another manner of determining the repetition quantity of the data transmission may be further included. This is not limited herein.

The following describes a first association relationship between the information about the reference signal and the information about the demodulation reference signal of the data transmission in the scheduling information.

In a possible implementation, the first association relationship is a correspondence between the RE location of the reference signal and the information about the demodulation reference signal of the data transmission in the scheduling information.

For example, the first RE location corresponds to first information of the demodulation reference signal, the second RE location corresponds to second information of the demodulation reference signal, and the third RE location corresponds to third information of the demodulation reference signal.

If the information about the demodulation reference signal is a scrambling identifier, the first association relationship is a correspondence between the RE location of the reference signal and the scrambling identifier of the demodulation reference signal. For example, the first RE location corresponds to a first scrambling identifier of the demodulation reference signal, the second RE location corresponds to a second scrambling identifier of the demodulation reference signal, and the third RE location corresponds to a third scrambling identifier of the demodulation reference signal. In this way, the information can be determined based on the RE location of the reference signal and the first association relationship between the RE location of the reference signal and the information about the demodulation reference signal of the data transmission in the scheduling information.

In a possible implementation, the first association relationship is a correspondence between the port number of the reference signal and the information about the demodulation reference signal of the data transmission in the scheduling information.

For example, the first port number corresponds to the first information of the demodulation reference signal, the second port number corresponds to the second information of the demodulation reference signal, and the third port number corresponds to the third information of the demodulation reference signal.

If the information about the demodulation reference signal is the scrambling identifier, the first association relationship is a correspondence between the port number of the reference signal and the scrambling identifier of the demodulation reference signal. For example, the first port number corresponds to the first scrambling identifier of the demodulation reference signal, the second port number corresponds to the second scrambling identifier of the demodulation reference signal, and the third port number corresponds to the third scrambling identifier of the demodulation reference signal.

For another example, port 0 and/or port 1 correspond/corresponds to the first information of the demodulation reference signal, port 2 and/or port 3 correspond/corresponds to the second information of the demodulation reference signal, and port 4 and/or port 5 correspond/corresponds to the third information of the demodulation reference signal.

If the information about the demodulation reference signal is the scrambling identifier, the first association relationship is a correspondence between the port number of the reference signal and the scrambling identifier of the demodulation reference signal. port 0 and/or port 1 correspond/corresponds to the first scrambling identifier of the demodulation reference signal, port 2 and/or port 3 correspond/corresponds to the second scrambling identifier of the demodulation reference signal, port 4 and/or port 5 correspond/corresponds to the third scrambling identifier of the demodulation reference signal, and so on. In this way, the information can be determined based on the port number of the reference signal and the first association relationship between the port number of the reference signal and the information about the demodulation reference signal of the data transmission in the scheduling information.

In a possible implementation, the first association relationship is a correspondence between the scrambling identifier of the sequence of the reference signal and the information about the demodulation reference signal of the data transmission in the scheduling information.

For example, the first scrambling identifier corresponds to the first information of the demodulation reference signal, the second scrambling identifier corresponds to the second information of the demodulation reference signal, and the third scrambling identifier corresponds to the third information of the demodulation reference signal.

If the information about the demodulation reference signal is the scrambling identifier, the first association relationship is a correspondence between the scrambling identifier of the sequence of the reference signal and the scrambling identifier of the demodulation reference signal. For example, the first scrambling identifier of the sequence of the reference signal corresponds to the first scrambling identifier of the demodulation reference signal, the second scrambling identifier of the sequence of the reference signal corresponds to the second scrambling identifier of the demodulation reference signal, and the third scrambling identifier of the sequence of the reference signal corresponds to the third scrambling identifier of the demodulation reference signal. In this way, the information can be determined based on the scrambling identifier of the sequence of the reference signal and the first association relationship between the scrambling identifier of the sequence of the reference signal and the information about the demodulation reference signal of the data transmission in the scheduling information.

In a possible implementation, the first association relationship is a correspondence between the root sequence of the sequence of the reference signal and the information about the demodulation reference signal in the scheduling information.

For example, the first root sequence corresponds to the first information of the demodulation reference signal, the second root sequence corresponds to the second information of the demodulation reference signal, and the third root sequence corresponds to the third information of the demodulation reference signal.

If the information about the demodulation reference signal is the scrambling identifier, the first association relationship is a correspondence between the root sequence of the sequence of the reference signal and the scrambling identifier of the demodulation reference signal. For example, the first root sequence of the sequence of the reference signal corresponds to the first scrambling identifier of the demodulation reference signal, the second root sequence of the sequence of the reference signal corresponds to the second scrambling identifier of the demodulation reference signal, and the third root sequence of the sequence of the reference signal corresponds to the third scrambling identifier of the demodulation reference signal. In this way, the information can be determined based on the root sequence of the sequence of the reference signal and the first association relationship between the root sequence of the sequence of the reference signal and the information about the demodulation reference signal of the data transmission in the scheduling information.

In a possible implementation, the first association relationship is a correspondence between the cyclic shift of the sequence of the reference signal and the information about the demodulation reference signal of the data transmission in the scheduling information.

For example, the first cyclic shift corresponds to the first information of the demodulation reference signal, the second cyclic shift corresponds to the second information of the demodulation reference signal, and the third cyclic shift corresponds to the third information of the demodulation reference signal.

If the information about the demodulation reference signal is the scrambling identifier, the first association relationship is a correspondence between the cyclic shift of the sequence of the reference signal and the scrambling identifier of the demodulation reference signal. For example, the first cyclic shift of the sequence of the reference signal corresponds to the first scrambling identifier of the demodulation reference signal, the second cyclic shift of the sequence of the reference signal corresponds to the second scrambling identifier of the demodulation reference signal, and the third cyclic shift of the sequence of the reference signal corresponds to the third scrambling identifier of the demodulation reference signal. In this way, the information can be determined based on the cyclic shift of the sequence of the reference signal and the first association relationship between the cyclic shift of the sequence of the reference signal and the information about the demodulation reference signal of the data transmission in the scheduling information.

Meanings of the first information, the second information, the third information, and the like of the demodulation reference signal may be predefined in a protocol, or may be notified by the first device to the second device via signaling. This is not limited in embodiments of this application. For example, if the information of the demodulation reference signal is the scrambling identifier, the first scrambling identifier i_{UE}=0, the second scrambling identifier i_{UE}=1, and the third scrambling identifier i_{UE}=3.

In a possible implementation, the first device configures a plurality of candidate values of the information about the demodulation reference signal, and there is a correspondence between each candidate value and at least one of the following information about the reference signal: the RE location, the port number, the sequence parameter, or the like.

It should be understood that the foregoing descriptions are examples of the first association relationship between the information about the reference signal and the information about the demodulation reference signal of the data transmission in the scheduling information. Actually, another first association relationship or another manner of determining the information about the demodulation reference signal may be further included. This is not limited herein.

The following describes a first association relationship between the information about the reference signal and the pattern of the data transmission in the scheduling information.

In a possible implementation, the first association relationship is a correspondence between the RE location of the reference signal and the pattern of the data transmission in the scheduling information.

For example, the first RE location corresponds to a first pattern of the data transmission, the second RE location corresponds to a second pattern of the data transmission, and the third RE location corresponds to a third pattern of the data transmission. In this way, the pattern can be determined based on the RE location of the reference signal and the first association relationship between the RE location of the reference signal and the pattern of the data transmission.

The pattern of the data transmission may alternatively be a pattern of the demodulation reference signal, and there is a correspondence between the two patterns. In a possible implementation, the first association relationship is a correspondence between the RE location of the reference signal and the pattern of the demodulation reference signal in the scheduling information.

For example, the first RE location corresponds to a first pattern of the demodulation reference signal, the second RE location corresponds to a second pattern of the demodulation reference signal, and the third RE location corresponds to a third pattern of the demodulation reference signal. In this way, the pattern can be determined based on the RE location of the reference signal and the first association relationship between the RE location of the reference signal and the pattern of the demodulation reference signal.

In a possible implementation, the first association relationship includes at least one of the following: a correspondence between the port number of the reference signal and the pattern of the data transmission in the scheduling information; or the first association relationship is a correspondence between the port number of the reference signal and the pattern of the demodulation reference signal in the scheduling information.

For example, the first port number corresponds to the first pattern of the data transmission, the second port number corresponds to the second pattern of the data transmission, and the third port number corresponds to the third pattern of the data transmission. For another example, port 0 and/or port 1 correspond/corresponds to the first pattern of the data transmission, port 2 and/or port 3 correspond/corresponds to the second pattern of the data transmission, and port 4 and/or port 5 correspond/corresponds to the third pattern of the data transmission. In this way, the pattern can be determined based on the port number of the reference signal and the first association relationship between the port number of the reference signal and the pattern of the data transmission.

For example, the first port number corresponds to the first pattern of the demodulation reference signal, the second port number corresponds to the second pattern of the demodulation reference signal, and the third port number corresponds to the third pattern of the demodulation reference signal. For another example, port 0 and/or port 1 correspond/corresponds to the first pattern, port 2 and/or port 3 correspond/corresponds to the second pattern of the demodulation reference signal, and port 4 and/or port 5 correspond/corresponds to the third pattern of the demodulation reference signal. In this way, the pattern can be determined based on the port number of the reference signal and the first association relationship between the port number of the reference signal and the pattern of the demodulation reference signal in the scheduling information.

In a possible implementation, the first association relationship includes at least one of the following: a correspondence between the scrambling identifier of the sequence of the reference signal and the pattern of the data transmission in the scheduling information; or the first association relationship is a correspondence between the scrambling identifier of the sequence of the reference signal and the pattern of the demodulation reference signal in the scheduling information.

For example, the first scrambling identifier corresponds to the first pattern of the data transmission, the second scrambling identifier corresponds to the second pattern of the data transmission, and the third scrambling identifier corresponds to the third pattern of the data transmission. In this way, the pattern can be determined based on the scrambling identifier of the sequence of the reference signal and the first association relationship between the scrambling identifier of the sequence of the reference signal and the pattern of the data transmission in the scheduling information.

For example, the first scrambling identifier corresponds to the first pattern of the demodulation reference signal, the second scrambling identifier corresponds to the second pattern of the demodulation reference signal, and the third scrambling identifier corresponds to the third pattern of the demodulation reference signal. In this way, the pattern can be determined based on the scrambling identifier of the sequence of the reference signal and the first association relationship between the scrambling identifier of the sequence of the reference signal and the pattern of the demodulation reference signal in the scheduling information.

In a possible implementation, the first association relationship includes at least one of the following: a correspondence between the root sequence of the sequence of the reference signal and the pattern of the data transmission in the scheduling information; or the first association relationship is a correspondence between the root sequence of the sequence of the reference signal and the pattern of the demodulation reference signal in the scheduling information.

For example, the first root sequence corresponds to the first pattern of the data transmission, the second root sequence corresponds to the second pattern of the data transmission, and the third root sequence corresponds to the third pattern of the data transmission. In this way, the pattern can be determined based on the root sequence of the sequence of the reference signal and the first association relationship between the root sequence of the sequence of the reference signal and the pattern of the data transmission in the scheduling information.

For example, the first root sequence corresponds to the first pattern of the demodulation reference signal, the second root sequence corresponds to the second pattern of the demodulation reference signal, and the third root sequence corresponds to the third pattern of the demodulation reference signal. In this way, the pattern can be determined based on the root sequence of the sequence of the reference signal and the first association relationship between the root sequence of the sequence of the reference signal and the pattern of the demodulation reference signal in the scheduling information.

In a possible implementation, the first association relationship includes at least one of the following: a correspondence between the cyclic shift of the sequence of the reference signal and the pattern of the data transmission in the scheduling information; or the first association relationship is a correspondence between the cyclic shift of the sequence of the reference signal and the pattern of the demodulation reference signal in the scheduling information.

For example, the first cyclic shift corresponds to the first pattern of the data transmission, the second cyclic shift corresponds to the second pattern of the data transmission, and the third cyclic shift corresponds to the third pattern of the data transmission. In this way, the pattern can be determined based on the cyclic shift of the sequence of the reference signal and the first association relationship between the cyclic shift of the sequence of the reference signal and the pattern of the data transmission in the scheduling information.

For example, the first cyclic shift corresponds to the first pattern of the demodulation reference signal, the second cyclic shift corresponds to the second pattern of the demodulation reference signal, and the third cyclic shift corresponds to the third pattern of the demodulation reference signal. In this way, the pattern can be determined based on the cyclic shift of the sequence of the reference signal and the first association relationship between the cyclic shift of the sequence of the reference signal and the pattern of the demodulation reference signal in the scheduling information.

Meanings of the first pattern, the second pattern, the third pattern, and the like may be predefined in a protocol, or may be notified by the first device to the second device via signaling. This is not limited in embodiments of this application. For example, for the first pattern of the data transmission, refer to A in FIG. 4; and for the second pattern of the data transmission, refer to A in FIG. 5. For another example, the first pattern of the demodulation reference signal may be B in FIG. 4, the second pattern of the demodulation reference signal may be B in FIG. 5, and for the third pattern of the data transmission, refer to A in FIG. 6.

In a possible implementation, the first device configures a plurality of candidate values of the pattern of the data transmission, and there is a correspondence between each candidate value and at least one of the following information about the reference signal: the RE location, the port number, the sequence parameter, or the like.

In a possible implementation, the first device configures a plurality of candidate values of the pattern of the demodulation reference signal, and there is a correspondence between each candidate value and at least one of the following information about the reference signal: the RE location, the port number, the sequence parameter, or the like.

It should be understood that the foregoing descriptions are examples of the first association relationship between the information about the reference signal and the pattern of the data transmission in the scheduling information. Actually, another first association relationship or another manner of determining the pattern of the data transmission may be further included. This is not limited herein. The foregoing descriptions are examples of the first association relationship between the information about the reference signal and the pattern of the demodulation reference signal in the scheduling information. Actually, another first association relationship or another manner of determining the pattern of the demodulation reference signal may be further included. This is not limited herein.

The following describes a first association relationship between the information about the reference signal and the redundancy version of the data transmission in the scheduling information.

In a possible implementation, the first association relationship is a correspondence between the RE location of the reference signal and the redundancy version of the data transmission in the scheduling information.

For example, the first RE location corresponds to a first redundancy version, the second RE location corresponds to a second redundancy version, and the third RE location corresponds to a third redundancy version. In this way, the redundancy version can be determined based on the RE location of the reference signal and the first association relationship between the RE location of the reference signal and the redundancy version of the data transmission in the scheduling information.

In a possible implementation, the first association relationship is a correspondence between the port number of the reference signal and the redundancy version of the data transmission in the scheduling information.

For example, the first port number corresponds to the first redundancy version, the second port number corresponds to the second redundancy version, and the third port number corresponds to the third redundancy version. For another example, port 0 and/or port 1 correspond/corresponds to the first redundancy version, port 2 and/or port 3 correspond/corresponds to the second redundancy version, and port 4 and/or port 5 correspond/corresponds to the third redundancy version. In this way, the redundancy version can be determined based on the port number of the reference signal and the first association relationship between the port number of the reference signal and the redundancy version of the data transmission in the scheduling information.

In a possible implementation, the first association relationship is a correspondence between the scrambling identifier of the sequence of the reference signal and the redundancy version of the data transmission in the scheduling information.

For example, the first scrambling identifier corresponds to the first redundancy version, the second scrambling identifier corresponds to the second redundancy version, and the third scrambling identifier corresponds to the third redundancy version. In this way, the redundancy version can be determined based on the scrambling identifier of the sequence of the reference signal and the first association relationship between the scrambling identifier of the sequence of the reference signal and the redundancy version of the data transmission in the scheduling information.

In a possible implementation, the first association relationship is a correspondence between the root sequence of the sequence of the reference signal and the redundancy version of the data transmission in the scheduling information.

For example, the first root sequence corresponds to the first redundancy version, the second root sequence corresponds to the second redundancy version, and the third root sequence corresponds to the third redundancy version. In this way, the redundancy version can be determined based on the root sequence of the sequence of the reference signal and the first association relationship between the root sequence of the sequence of the reference signal and the redundancy version of the data transmission in the scheduling information.

In a possible implementation, the first association relationship is a correspondence between the cyclic shift of the sequence of the reference signal and the redundancy version of the data transmission in the scheduling information.

For example, the first cyclic shift corresponds to the first redundancy version, the second cyclic shift corresponds to the second redundancy version, and the third cyclic shift corresponds to the third redundancy version. In this way, the redundancy version can be determined based on the cyclic shift of the sequence of the reference signal and the first association relationship between the cyclic shift of the sequence of the reference signal and the redundancy version of the data transmission in the scheduling information.

The first redundancy version, the second redundancy version, the third redundancy version, and the like may be predefined in a protocol, or may be notified by the first device to the second device via signaling. This is not limited in embodiments of this application. For example, the first redundancy version is {0,0,0,0}, the second redundancy version is {0,2,3,1}, and the third redundancy version is {0,3,0,3}.

Optionally, the first device may configure a plurality of candidate values of the redundancy version, and there is a correspondence between each candidate value and at least one of the following information about the reference signal: the RE location, the port number, the sequence parameter, or the like.

It should be understood that the foregoing descriptions are examples of the first association relationship between the information about the reference signal and the redundancy version of the data transmission in the scheduling information. Actually, another first association relationship or another manner of determining the redundancy version of the data transmission may be further included. This is not limited herein.

The following describes a first association relationship between the information about the reference signal and the new data indicator of the data transmission in the scheduling information.

In a possible implementation, the first association relationship is a correspondence between the RE location of the reference signal and the new data indicator of the data transmission in the scheduling information.

For example, the first RE location corresponds to a first NDI, and the second RE location corresponds to a second NDI. In this way, the new data indicator can be determined based on the RE location of the reference signal and the first association relationship between the RE location of the reference signal and the new data indicator of the data transmission in the scheduling information.

In a possible implementation, the first association relationship is a correspondence between the port number of the reference signal and the new data indicator of the data transmission in the scheduling information.

For example, the first port number corresponds to the first NDI, and the second port number corresponds to the second NDI. For another example, port 0 and/or port 1 correspond/corresponds to the first NDI, and port 2 and/or port 3 correspond/corresponds to the second NDI. In this way, the new data indicator can be determined based on the port number of the reference signal and the first association relationship between the port number of the reference signal and the new data indicator of the data transmission in the scheduling information.

In a possible implementation, the first association relationship is a correspondence between the scrambling identifier of the sequence of the reference signal and the new data indicator of the data transmission in the scheduling information.

For example, the first scrambling identifier corresponds to the first NDI, and the second scrambling identifier corresponds to the second NDI. In this way, the new data indicator can be determined based on the scrambling identifier of the sequence of the reference signal and the first association relationship between the scrambling identifier of the sequence of the reference signal and the new data indicator of the data transmission in the scheduling information.

In a possible implementation, the first association relationship is a correspondence between the root sequence of the sequence of the reference signal and the new data indicator of the data transmission in the scheduling information.

For example, the first root sequence corresponds to the first NDI, and the second root sequence corresponds to the second NDI. In this way, the new data indicator can be determined based on the root sequence of the sequence of the reference signal and the first association relationship between the root sequence of the sequence of the reference signal and the new data indicator of the data transmission in the scheduling information.

In a possible implementation, the first association relationship is a correspondence between the cyclic shift of the sequence of the reference signal and the new data indicator of the data transmission in the scheduling information.

For example, the first cyclic shift corresponds to the first NDI, and the second cyclic shift corresponds to the second NDI. In this way, the new data indicator can be determined based on the cyclic shift of the sequence of the reference signal and the first association relationship between the cyclic shift of the sequence of the reference signal and the new data indicator of the data transmission in the scheduling information.

The first NDI, the second NDI, and the like may be predefined in a protocol, or may be notified by the first device to the second device via signaling. This is not limited in embodiments of this application. For example, if the first NDI is 0, it indicates that the data is data whose new transmission is performed; and if the second NDI is 1, it indicates that the data is data whose retransmission is performed. For another example, if the first NDI is 0, it indicates that the data is sent sidelink data; and if the second NDI is 1, it indicates that the data is received sidelink data.

In a possible implementation, the first device may configure a plurality of candidate values of the new data indicator, and there is a correspondence between each candidate value and at least one of the following information about the reference signal: the RE location, the port number, the sequence parameter, or the like.

It should be understood that the foregoing descriptions are examples of the first association relationship between the information about the reference signal and the new data indicator of the data transmission in the scheduling information. Actually, another first association relationship or another manner of determining the new data indicator of the data transmission may be further included. This is not limited herein.

The following describes a first association relationship between the information about the reference signal and the transmission power information of the data transmission in the scheduling information.

In a possible implementation, the first association relationship is a correspondence between the RE location of the reference signal and the transmission power information of the data transmission in the scheduling information.

For example, the first RE location corresponds to first transmission power information, the second RE location corresponds to second transmission power information, and the third RE location corresponds to third transmission power information. In this way, the transmission power information can be determined based on the RE location of the reference signal and the first association relationship between the RE location of the reference signal and the transmission power information of the data transmission in the scheduling information.

In a possible implementation, the first association relationship is a correspondence between the port number of the reference signal and the transmission power information of the data transmission in the scheduling information.

For example, the first port number corresponds to the first transmission power information, the second port number corresponds to the second transmission power information, and the third port number corresponds to the third transmission power information. For another example, port 0 and/or port 1 correspond/corresponds to the first transmission power information, port 2 and/or port 3 correspond/corresponds to the second transmission power information, and port 4 and/or port 5 correspond/corresponds to the third transmission power information. In this way, the transmission power information can be determined based on the port number of the reference signal and the first association relationship between the port number of the reference signal and the transmission power information of the data transmission in the scheduling information.

In a possible implementation, the first association relationship is a correspondence between the scrambling identifier of the sequence of the reference signal and the transmission power information of the data transmission in the scheduling information.

For example, the first scrambling identifier corresponds to the first transmission power information, the second scrambling identifier corresponds to the second transmission power information, and the third scrambling identifier corresponds to the third transmission power information. In this way, the transmission power information can be determined based on the scrambling identifier of the sequence of the reference signal and the first association relationship between the scrambling identifier of the sequence of the reference signal and the transmission power information of the data transmission in the scheduling information.

In a possible implementation, the first association relationship is a correspondence between the root sequence of the sequence of the reference signal and the transmission power information of the data transmission in the scheduling information.

For example, the first root sequence corresponds to the first transmission power information, the second root sequence corresponds to the second transmission power information, and the third root sequence corresponds to the third transmission power information. In this way, the transmission power information can be determined based on the root sequence of the sequence of the reference signal and the first association relationship between the root sequence of the sequence of the reference signal and the transmission power information of the data transmission in the scheduling information.

In a possible implementation, the first association relationship is a correspondence between the cyclic shift of the sequence of the reference signal and the transmission power information of the data transmission in the scheduling information.

For example, the first cyclic shift corresponds to the first transmission power information, the second cyclic shift corresponds to the second transmission power information, and the third cyclic shift corresponds to the third transmission power information. In this way, the transmission power information can be determined based on the cyclic shift of the sequence of the reference signal and the first association relationship between the cyclic shift of the sequence of the reference signal and the transmission power information of the data transmission in the scheduling information.

The first transmission power information, the second transmission power information, the third transmission power information, and the like may be predefined in a protocol, or may be notified by the first device to the second device via signaling. This is not limited in embodiments of this application. For example, the first transmission power information is first TPC command, the second transmission power information is second TPC command, and the third transmission power information is third TPC command. For another example, the first transmission power information indicates that a ratio of power of the data to power of the demodulation reference signal is 0 dB, the second transmission power information indicates that the ratio of the power of the data to the power of the demodulation reference signal is −3 dB, and the third transmission power information indicates that the ratio of the power of the data to the power of the demodulation reference signal is −4.77 dB.

In a possible implementation, the first device may configure a plurality of candidate values of the transmission power information, and there is a correspondence between each candidate value and at least one of the following information about the reference signal: the RE location, the port number, the sequence parameter, or the like.

It should be understood that the foregoing descriptions are examples of the first association relationship between the information about the reference signal and the transmission power information of the data transmission in the scheduling information. Actually, another first association relationship or another manner of determining the transmission power information of the data transmission may be further included. This is not limited herein.

The following describes a first association relationship between the information about the reference signal and the transmission type indication of the data transmission in the scheduling information.

In a possible implementation, the first association relationship is a correspondence between the RE location of the reference signal and the transmission type indication of the data transmission in the scheduling information.

For example, the first RE location corresponds to a first transmission type indication, the second RE location corresponds to a second transmission type indication, the third RE location corresponds to a third transmission type indication, and a fourth RE location corresponds to a fourth transmission type indication. In this way, the transmission type indication can be determined based on the RE location of the reference signal and the first association relationship between the RE location of the reference signal and the transmission type indication of the data transmission in the scheduling information. Optionally, the first association relationship is a correspondence between the port number of the reference signal and the transmission type indication of the data transmission in the scheduling information.

For example, the first port number corresponds to the first transmission type indication, the second port number corresponds to the second transmission type indication, the third port number corresponds to the third transmission type indication, and a fourth port number corresponds to the fourth transmission type indication. For another example, port 0 and/or port 1 correspond/corresponds to the first transmission type indication, port 2 and/or port 3 correspond/corresponds to the second transmission type indication, and port 4 and/or port 5 correspond/corresponds to the third transmission type indication. In this way, the transmission type indication can be determined based on the port number of the reference signal and the first association relationship between the port number of the reference signal and the transmission type indication of the data transmission in the scheduling information.

In a possible implementation, the first association relationship is a correspondence between the scrambling identifier of the sequence of the reference signal and the transmission type indication of the data transmission in the scheduling information.

For example, the first scrambling identifier corresponds to the first transmission type indication, the second scrambling identifier corresponds to the second transmission type indication, the third scrambling identifier corresponds to the third transmission type indication, and a fourth scrambling identifier corresponds to the fourth transmission type indication. In this way, the transmission type indication can be determined based on the scrambling identifier of the sequence of the reference signal and the first association relationship between the scrambling identifier of the sequence of the reference signal and the transmission type indication of the data transmission in the scheduling information.

In a possible implementation, the first association relationship is a correspondence between the root sequence of the sequence of the reference signal and the transmission type indication of the data transmission in the scheduling information.

For example, the first root sequence corresponds to the first transmission type indication, the second root sequence corresponds to the second transmission type indication, the third root sequence corresponds to the third transmission type indication, and a fourth root sequence corresponds to the fourth transmission type indication. In this way, the transmission type indication can be determined based on the root sequence of the sequence of the reference signal and the first association relationship between the root sequence of the sequence of the reference signal and the transmission type indication of the data transmission in the scheduling information.

In a possible implementation, the first association relationship is a correspondence between the cyclic shift of the sequence of the reference signal and the transmission type indication of the data transmission in the scheduling information.

For example, the first cyclic shift corresponds to the first transmission type indication, the second cyclic shift corresponds to the second transmission type indication, the third cyclic shift corresponds to the third transmission type indication, and a fourth cyclic shift corresponds to the fourth transmission type indication. In this way, the transmission type indication can be determined based on the cyclic shift of the sequence of the reference signal and the first association relationship between the cyclic shift of the sequence of the reference signal and the transmission type indication of the data transmission in the scheduling information.

The first transmission type indication, the second transmission type indication, the third transmission type indication, the fourth transmission type indication, or the like may be predefined in a protocol, or may be notified by the first device to the second device via signaling. This is not limited in embodiments of this application. For example, the first transmission type indication indicates sent data, the second transmission type indication indicates received data, the third transmission type indication indicates sent sidelink data, and the fourth transmission type indication indicates received sidelink data.

In a possible implementation, the first device may configure a plurality of candidate values of the transmission type indication, and there is a correspondence between each candidate value and at least one of the following information about the reference signal: the RE location, the port number, the sequence parameter, or the like.

It should be understood that the foregoing descriptions are examples of the first association relationship between the information about the reference signal and the transmission type indication of the data transmission in the scheduling information. Actually, another first association relationship or another manner of determining the transmission type indication of the data transmission may be further included. This is not limited herein.

The foregoing describes the first association relationship between one piece of information about the reference signal and one piece of scheduling information, so that the scheduling information can be determined based on the piece of information about the reference signal and the first association relationship between the piece of information about the reference signal and the piece of scheduling information. In some feasible examples, the first association relationship is an association relationship between one piece of information about the reference signal and a plurality of pieces of scheduling information. The communication method may further include: determining the plurality of pieces of scheduling information based on one piece of information about the reference signal and the first association relationship between the piece of information about the reference signal and the plurality of pieces of scheduling information.

In a possible implementation, there is a first association relationship between the RE location of the reference signal and a plurality of pieces of scheduling information.

For example, the first RE location of the reference signal corresponds to at least two of the following of the data transmission: a first time domain resource, a first frequency domain resource, the first modulation scheme, the first code rate, the first transmission configuration indication, the first repetition quantity, the first information of the demodulation reference signal, the first pattern, the first redundancy version, a first new data indicator, the first transmission power information, and the first transmission type indication; and the second RE location of the reference signal corresponds to at least two of the following of the data transmission: a second time domain resource, a second frequency domain resource, the second modulation scheme, the second code rate, the second transmission configuration indication, the second repetition quantity, the second information of the demodulation reference signal, the second pattern, the second redundancy version, a second new data indicator, the second transmission power information, and the second transmission type indication.

In a possible implementation, there is a first association relationship between the port number of the reference signal and a plurality of pieces of scheduling information.

For example, the first port number of the reference signal corresponds to at least two of the following of the data transmission: the first time domain resource, the first frequency domain resource, the first modulation scheme, the first code rate, the first transmission configuration indication, the first repetition quantity, the first information of the demodulation reference signal, the first pattern, the first redundancy version, the first new data indicator, the first transmission power information, and the first transmission type indication; and the second port number of the reference signal corresponds to at least two of the following of the data transmission: the second time domain resource, the second frequency domain resource, the second modulation scheme, the second code rate, the second transmission configuration indication, the second repetition quantity, the second information of the demodulation reference signal, the second pattern, the second redundancy version, the second new data indicator, the second transmission power information, and the second transmission type indication.

In a possible implementation, there is a first association relationship between the sequence parameter of the reference signal and a plurality of pieces of scheduling information.

For example, a first sequence parameter of the reference signal corresponds to at least two of the following of the data transmission: the first time domain resource, the first frequency domain resource, the first modulation scheme, the first code rate, the first transmission configuration indication, the first repetition quantity, the first information of the demodulation reference signal, the first pattern, the first redundancy version, the first new data indicator, the first transmission power information, and the first transmission type indication; and a second sequence parameter of the reference signal corresponds to at least two of the following of the data transmission: the second time domain resource, the second frequency domain resource, the second modulation scheme, the second code rate, the second transmission configuration indication, the second repetition quantity, the second information of the demodulation reference signal, the second pattern, the second redundancy version, the second new data indicator, the second transmission power information, and the second transmission type indication. The first sequence parameter and the second sequence parameter herein may be at least one of the scrambling identifier, the root identifier, the cyclic shift, or the like.

For example, Table 5 describes an association relationship between one piece of information about the reference signal and a plurality of pieces of scheduling information. The first association relationship may include at least one row or at least one column in Table 5.

TABLE 5

| | Data transmission | | | |
|---|---|---|---|---|
| Reference | Time-frequency | | Repetition | |
| signal | resource identifier | MCS identifier | quantity | Pattern |
| An RE location | First identifier | 0 | 2 | First |
| identifier is 0 | | | | pattern |
| An RE location | Second identifier | 1 | 3 | Second |
| identifier is 1 | | | | pattern |
| An RE location | Third identifier | 2 | 4 | Third |
| identifier is 2 | | | | pattern |

As shown in Table 5, based on the RE location identifier of the reference signal, at least two of the following of the data transmission can be determined: the time-frequency resource identifier, the MCS identifier, the repetition quantity, and the pattern of the data transmission.

Alternatively, Table 6 describes an association relationship between one piece of information about the reference signal and a plurality of pieces of scheduling information. The second association relationship may include at least one row or at least one column in Table 6.

TABLE 6

| | Data transmission | | |
|---|---|---|---|
| | New data | | |
| Reference signal | indicator | Redundancy version | Transmission power |
| The scrambling | 0 | First redundancy | First transmission |
| identifier of the | | version | power |
| sequence is 0 | | | |
| The scrambling | 1 | Second redundancy | Second transmission |
| identifier of the | | version | power |
| sequence is 1 | | | |
| The scrambling | 0 | Third redundancy | Third transmission |
| identifier of the | | version | power |
| sequence is 2 | | | |

As shown in Table 6, based on the scrambling identifier of the sequence of the reference signal, at least two of the following of the data transmission can be determined: the new data indicator, the redundancy version, and the transmission power. It may be understood that, determining a plurality of pieces of information about the data transmission by using one piece of information about the reference signal can improve efficiency of determining the scheduling information, and help improve efficiency of the data transmission.

It should be understood that the foregoing descriptions are examples of the first association relationship between one piece of information about the reference signal and the plurality of pieces of scheduling information. Actually, another first association relationship or another manner of determining the plurality of pieces of scheduling information may be further included. This is not limited herein. For a method for determining one or more pieces of scheduling information based on a plurality of pieces of information about the reference signal, refer to the foregoing descriptions. The scheduling information may be determined based on one piece of information about the reference signal and the first association relationship between the piece of information about the reference signal and the scheduling information, or the scheduling information may be determined based on a plurality of pieces of information about the reference signal and the first association relationship between the plurality of pieces of information about the reference signal and the scheduling information.

The foregoing descriptions are examples of determining the scheduling information based on the information about the reference signal, and a method for determining another piece of scheduling information based on one piece of scheduling information may be further included. In some feasible examples, the scheduling information includes first information and second information, and there is a third association relationship between the first information and the second information. The communication method further includes: determining the second information based on the first information and the third association relationship. In this way, the information about the reference signal can be associated with the first information, and the information about the reference signal is not associated with the second information, thereby reducing signaling overheads. The second information is determined based on the first information and the third association relationship between the first information and the second information, so that efficiency of determining the scheduling information can be improved.

A type of the first information, a type of the second information, and the third association relationship are not limited in this application. Optionally, the first information may be a modulation scheme, and the second information may be a code rate; or the first information may be a code rate, and the second information may be a modulation scheme. The third association relationship is a correspondence between the modulation scheme and the code rate.

For example, for the third association relationship between the modulation scheme and the code rate, refer to Table 7. Table 7 is used to describe a relationship between the MCS identifier and each of the modulation scheme, a target code rate, and spectral efficiency. For example, when the MCS identifier is 1, a modulation order is 2, the target code rate is 40, and the spectral efficiency is 0.0781.

TABLE 7

| MCS | Modulation | Target code | Spectral |
|---|---|---|---|
| identifier | order | rate [1024] | efficiency |
| 0 | 2 | 30 | 0.0586 |
| 1 | 2 | 40 | 0.0781 |
| 2 | 2 | 50 | 0.0977 |
| 3 | 2 | 64 | 0.1250 |
| 4 | 2 | 78 | 0.1523 |

In this way, the code rate can be determined based on the modulation scheme, and the modulation scheme can be determined based on the code rate, so that the information about the reference signal can be associated with the modulation scheme or the code rate. This helps reduce signaling overheads and improve efficiency of determining the scheduling information. It should be noted that Table 7 is an example. Actually, there may be another MCS. For example, MCS identifiers are 5 to 31, and modulation orders may further include 4 and 6.

In a possible implementation, the first information may be the modulation scheme and/or the code rate, and the second information may be the repetition quantity; or the first information may be the repetition quantity, and the second information may be the modulation scheme and/or the code rate. The third association relationship may be a correspondence between the modulation scheme and/or the code rate and the repetition quantity. For example, for the third association relationship between the repetition quantity and each of the modulation scheme and the code rate, refer to Table 8. Table 8 is used to describe the relationship between the repetition quantity and each of the modulation scheme and the code rate. For example, when the modulation scheme is QPSK, the code rate is less than or equal to 0.5, and the repetition quantity is 3.

TABLE 8

| Modulation scheme | Code rate | Repetition quantity |
|---|---|---|
| QPSK | <=0.5 | 3 |
| QPSK | >0.5 | 4 |
| 16QAM | <=0.3 | 4 |
| 16QAM | >0.3 | 5 |

For another example, an example in which the modulation scheme is an MCS is used for description. For the third association relationship between the modulation scheme and the repetition quantity, refer to Table 9. Table 9 is used to describe a relationship between the MCS identifier and the repetition quantity. For example, when the MCS identifier is 1, the repetition quantity is 3.

TABLE 9

| MCS identifier | Repetition quantity |
|---|---|
| 0 | 2 |
| 1 | 3 |
| 2 | 4 |
| 3 | 5 |

In this way, the repetition quantity can be determined based on the modulation scheme and/or the code rate, or the modulation scheme and/or the code rate can be determined based on the repetition quantity, so that the information about the reference signal can be associated with the repetition quantity, or can be associated with the modulation scheme and/or the code rate. This helps reduce signaling overheads and improve efficiency of determining the scheduling information.

It should be understood that the foregoing descriptions are examples of the third association relationship between one piece of scheduling information and another piece of scheduling information. Actually, another third association relationship or another manner of determining the scheduling information may be further included. This is not limited herein.

This application may further include a method for determining another piece of information about the reference signal based on one piece of information about the reference signal,. In some feasible examples, the information about the reference signal includes third information and fourth information, and there is a fourth association relationship between the third information and the fourth information. The communication method may further include: determining the fourth information based on the third information and the fourth association relationship.

A type of the third information, a type of the fourth information, and the fourth association relationship are not limited in this application. Optionally, the third information is the RE location of the reference signal, and the fourth information is the pattern of the reference signal. Alternatively, the third information is the pattern of the reference signal, and the fourth information is the RE location of the reference signal. The fourth association relationship is a correspondence between the RE location of the reference signal and the pattern of the reference signal.

For example, the first RE location corresponds to a first pattern of the reference signal, the second RE location corresponds to a second pattern of the reference signal, and the third RE location corresponds to a third pattern of the reference signal. In this way, the pattern of the reference signal can be determined based on the RE location of the reference signal and the fourth association relationship.

Optionally, the third information is the port number of the reference signal, and the fourth information is the pattern of the reference signal. Alternatively, the third information is the pattern of the reference signal, and the fourth information is the port number. The fourth association relationship is a correspondence between the port number of the reference signal and the pattern of the reference signal.

For example, the first port number corresponds to the first pattern of the reference signal, the second port number corresponds to the second pattern of the reference signal, and the third port number corresponds to the third pattern of the reference signal. For another example, port 0 and/or port 1 correspond/corresponds to the first pattern of the reference signal, port 2 and/or port 3 correspond/corresponds to the second pattern of the reference signal, and port 4 and/or port 5 correspond/corresponds to the third pattern of the reference signal. In this way, the pattern of the reference signal can be determined based on the port number of the reference signal and the fourth association relationship.

Optionally, the third information is the scrambling identifier of the sequence of the reference signal, and the fourth information is the pattern of the reference signal. Alternatively, the third information is the pattern of the reference signal, and the fourth information is the scrambling identifier of the sequence of the reference signal. The fourth association relationship is a correspondence between the scrambling identifier of the sequence of the reference signal and the pattern of the reference signal.

For example, the first scrambling identifier corresponds to the first pattern of the reference signal, the second scrambling identifier corresponds to the second pattern of the reference signal, and the third scrambling identifier corresponds to the third pattern of the reference signal. In this way, the pattern of the reference signal can be determined based on the scrambling identifier of the sequence of the reference signal and the fourth association relationship between the scrambling identifier of the sequence of the reference signal and the pattern of the reference signal.

Optionally, the third information is the root sequence of the sequence of the reference signal, and the fourth information is the pattern of the reference signal. Alternatively, the third information is the pattern of the reference signal, and the fourth information is the root sequence of the sequence of the reference signal. The fourth association relationship is a correspondence between the root sequence of the sequence of the reference signal and the pattern of the reference signal.

For example, the first root sequence corresponds to the first pattern of the reference signal, the second root sequence corresponds to the second pattern of the reference signal, and the third root sequence corresponds to the third pattern of the reference signal. In this way, the pattern of the reference signal can be determined based on the root sequence of the sequence of the reference signal and the fourth association relationship between the root sequence of the sequence of the reference signal and the pattern of the reference signal.

Optionally, the third information is the cyclic shift of the sequence of the reference signal, and the fourth information is the pattern of the reference signal. Alternatively, the third information is the pattern of the reference signal, and the fourth information is the cyclic shift of the sequence of the reference signal. The fourth association relationship is a correspondence between the cyclic shift of the sequence of the reference signal and the pattern of the reference signal.

For example, the first cyclic shift corresponds to the first pattern of the reference signal, the second cyclic shift corresponds to the second pattern of the reference signal, and the third cyclic shift corresponds to the third pattern of the reference signal. In this way, the pattern of the reference signal can be determined based on the cyclic shift of the sequence of the reference signal and the fourth association relationship between the cyclic shift of the sequence of the reference signal and the pattern of the reference signal.

The first pattern, the second pattern, the third pattern, and the like of the reference signal may be predefined in a protocol, or may be notified by the first device to the second device via signaling. This is not limited in embodiments of this application. For example, for the first pattern of the reference signal, refer to A in FIG. 7; for the second pattern of the reference signal, refer to B in FIG. 7; and for the third pattern of the reference signal, refer to C in FIG. 7.

Optionally, the first device may configure a plurality of candidate values of the pattern of the reference signal, and there is a correspondence between each candidate value and at least one RE location of the reference signal; and/or the first device may configure a plurality of candidate values of the pattern of the reference signal, and there is a correspondence between each candidate value and at least one port number of the reference signal; and/or the first device may configure a plurality of candidate values of the pattern of the reference signal, and there is a correspondence between each candidate value and at least one sequence parameter of the reference signal.

It should be understood that the foregoing descriptions are examples of the fourth association relationship between one piece of information of the reference signal and another piece of information of the reference signal. Actually, another fourth association relationship or another manner of determining the information of the reference signal may be further included. This is not limited herein.

Step S102: The first device and the second device perform the data transmission based on the scheduling information.

In the communication method shown in FIG. 3, after receiving the reference signal from the first device, the second device may determine the scheduling information based on the association relationship between the information about the reference signal and the scheduling information of the data transmission, and then perform the data transmission based on the scheduling information. In this way, the scheduling information is implicitly indicated by the reference signal, instead of performing transmission on the reference signal and the scheduling information separately. In comparison with a manner of separately sending the scheduling information, overheads of the scheduling information can be reduced, and complexity and a latency of blind detection can be reduced, thereby improving efficiency of the data transmission.

The foregoing describes the methods in embodiments of this application in detail. The following provides apparatuses in embodiments of this application.

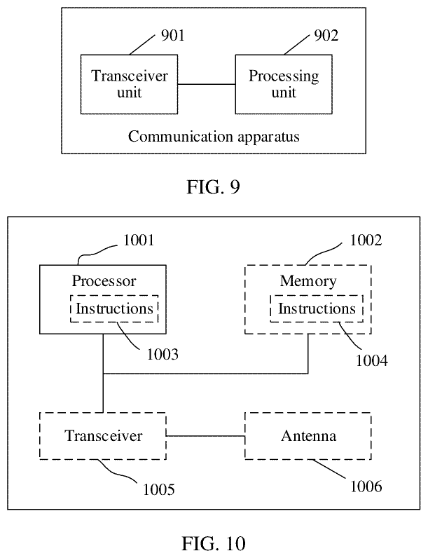

FIG. 9 is a diagram of a structure of a communication apparatus according to an embodiment of this application. The communication apparatus may include a transceiver unit 901 and a processing unit 902. The transceiver unit 901 may be a signal input (receiving) or output (sending) apparatus, and is configured to perform signal transmission with another device or another component in the device.

The processing unit 902 may be an apparatus having a processing function, and may include one or more processors. The processor may be a general-purpose processor, a dedicated processor, or the like. The processor may be a baseband processor or a central processing unit. The baseband processor may be configured to process a communication protocol and communication data. The central processing unit may be configured to: control an apparatus (for example, a donor node, a relay node, or a chip), execute a software program, and process data of the software program.

The communication apparatus may include a first device and a second device. The first device may be a network device or a terminal device. The second device may be a terminal device different from the first device.

When the communication apparatus is the second device, the transceiver unit 901 is configured to receive a reference signal, where there is a first association relationship between information about the reference signal and scheduling information of data transmission, and the scheduling information includes at least one of the following of the data transmission: a time domain resource, a frequency domain resource, a modulation scheme, a code rate, a transmission configuration indication, a repetition quantity, information about a demodulation reference signal, a pattern, a redundancy version, a new data indicator, transmission power information, or a transmission type indication. The transceiver unit 901 is further configured to perform the data transmission based on the scheduling information.

In some feasible examples, the information about the reference signal includes at least one of the following of the reference signal: a signal class, a sequence parameter, a time domain resource, a frequency domain resource, a transmission configuration indication, or a pattern.

In some feasible examples, the transceiver unit 901 is further configured to: receive configuration information, where the configuration information indicates one or more candidate values of the information about the reference signal, and there is a second association relationship between the candidate value and the one or more pieces of scheduling information; or the configuration information indicates a second association relationship, and the second association relationship indicates one or more candidate values of the information about the reference signal; and the second association relationship includes the first association relationship; and receive the reference signal based on the configuration information.

In some feasible examples, the signal class of the reference signal includes at least one of the following: a CSI-RS, a DMRS, a PT-RS, an SRS, or an RS DCI.

In some feasible examples, the sequence parameter includes at least one of the following of a sequence: a sequence type, a scrambling identifier, a root identifier, or a cyclic shift.

In some feasible examples, a transmission type of the data transmission is determined based on the signal class of the reference signal.

In some feasible examples, a time-frequency resource for the data transmission and a time-frequency resource for the reference signal meet at least one of the following: the frequency domain resource for the data transmission is the same as the frequency domain resource for the reference signal; the information about the reference signal indicates that there is a frequency domain offset between the frequency domain resource for the data transmission and the frequency domain resource for the reference signal; the time domain resource for the data transmission is the same as the time domain resource for the reference signal; or the information about the reference signal indicates that there is a time domain offset between the time domain resource for the data transmission and the time domain resource for the reference signal.

In some feasible examples, the time domain resource for the data transmission includes a quantity of time domain symbols occupied for one single data transmission, and the information about the reference signal indicates the quantity of time domain symbols.

In some feasible examples, the scheduling information includes first information and second information, and there is a third association relationship between the first information and the second information. The processing unit 902 is configured to determine the second information based on the first information and the third association relationship.

When the communication apparatus is the first device, the transceiver unit 901 is configured to send a reference signal, where there is a first association relationship between information about the reference signal and scheduling information of data transmission, and the scheduling information includes at least one of the following of the data transmission: a time domain resource, a frequency domain resource, a modulation scheme, a code rate, a transmission configuration indication, a repetition quantity, information about a demodulation reference signal, a pattern, a redundancy version, a new data indicator, transmission power information, and/or a transmission type indication. The transceiver unit 901 is further configured to perform the data transmission based on the scheduling information.

In some feasible examples, the information about the reference signal includes at least one of the following of the reference signal: a signal class, a sequence parameter, a time domain resource, a frequency domain resource, a transmission configuration indication, and/or a pattern.

In some feasible examples, the transceiver unit 901 is further configured to: send configuration information, where the configuration information indicates one or more candidate values of the information about the reference signal, and there is a second association relationship between the candidate value and the one or more pieces of scheduling information; or the configuration information indicates a second association relationship, and the second association relationship indicates one or more candidate values of the information about the reference signal; and the second association relationship includes the first association relationship; and send the reference signal based on the configuration information.

In some feasible examples, the signal class of the reference signal includes at least one of the following: a CSI-RS, a DMRS, a PT-RS, an SRS, and/or an RS DCI.

In some feasible examples, the sequence parameter includes at least one of the following of a sequence: a sequence type, a scrambling identifier, a root identifier, and/or a cyclic shift.

In some feasible examples, a time-frequency resource for the data transmission and a time-frequency resource for the reference signal meet at least one of the following: the frequency domain resource for the data transmission is the same as the frequency domain resource for the reference signal; the information about the reference signal indicates that there is a frequency domain offset between the frequency domain resource for the data transmission and the frequency domain resource for the reference signal; the time domain resource for the data transmission is the same as the time domain resource for the reference signal; or the information about the reference signal indicates that there is a time domain offset between the time domain resource for the data transmission and the time domain resource for the reference signal.

In some feasible examples, the time domain resource for the data transmission includes a quantity of time domain symbols occupied for one single data transmission, and the information about the reference signal indicates the quantity of time domain symbols.

In some feasible examples, the scheduling information includes first information and second information, and there is a third association relationship between the first information and the second information.

For implementation of the transceiver unit 901 and the processing unit 902, refer to the related descriptions in the method embodiments shown in FIG. 3. Details are not described herein again.

FIG. 10 is a diagram of a structure of another communication apparatus according to an embodiment of this application. As shown in FIG. 10, the communication apparatus may include one or more processors 1001. The processor 1001 may also be referred to as a processing unit, and can implement a specific control function. The processor 1001 may be a general-purpose processor, a dedicated processor, or the like, and may be, for example, a baseband processor or a central processing unit. The baseband processor may be configured to process a communication protocol and communication data. The central processing unit may be configured to control a communication apparatus (for example, a base station, a baseband chip, a terminal, a terminal chip, a DU, or a CU), execute a software program, and process data of the software program.

In an optional design, the processor 1001 may store instructions 1003 and/or data, and the instructions 1003 and/or the data may be executed by the processor, so that the communication apparatus performs the method described in the foregoing method embodiments.

In another optional design, the processor 1001 may include a transceiver unit configured to implement receiving and sending functions. For example, the transceiver unit may be a transceiver circuit, an interface, an interface circuit, or a communication interface. The transceiver circuit, the interface, or the interface circuit configured to implement the receiving and sending functions may be separated, or may be integrated together. The transceiver circuit, the interface, or the interface circuit may be configured to read and write code/data, or the transceiver circuit, the interface, or the interface circuit may be configured for transmission or transfer of a signal.

In still another possible design, the communication apparatus may include a circuit, and the circuit can implement the sending, receiving, or communication function in the foregoing method embodiments.

Optionally, the communication apparatus may include one or more memories 1002 that may store instructions 1004. The instructions may be executed on the processor, so that the communication apparatus performs the method described in the foregoing method embodiments. Optionally, the memory may further store data. Optionally, the processor may further store instructions and/or data. The processor and the memory may be separately disposed, or may be integrated. For example, the correspondence described in the foregoing method embodiments may be stored in the memory or stored in the processor.

Optionally, the communication apparatus may further include a transceiver 1005 and/or an antenna 1006. The processor 1001 may be referred to as a processing unit, and controls the communication apparatus. The transceiver 1005 may be referred to as a transceiver unit, a transceiver machine, a transceiver circuit, a transceiver apparatus, a transceiver module, or the like, and is configured to implement receiving and sending functions.

Optionally, the communication apparatus may be configured to perform any method described in FIG. 3 in embodiments of this application.

In an embodiment, the communication apparatus may be a terminal device, an apparatus in the terminal device, or an apparatus that can be used together with the terminal device. When computer program instructions stored in the memory 1002 are executed, the processor 1001 is configured to perform an operation performed by the processing unit 902 in the foregoing embodiments. The transceiver 1005 is configured to perform an operation performed by the transceiver unit 901 in the foregoing embodiments, and the transceiver 1005 is further configured to send information to another communication apparatus than the communication apparatus. The terminal device or the apparatus in the terminal device may be further configured to perform any method performed by the terminal device in the method embodiments in FIG. 3. Details are not described herein again.

In an embodiment, the communication apparatus may be a network device, an apparatus in the network device, or an apparatus that can be used together with the network device. When computer program instructions stored in the memory 1002 are executed, the processor 1001 is configured to control the transceiver 1005 to perform an operation performed by the transceiver unit 901 in the foregoing embodiments. The transceiver 1005 is further configured to receive information from another communication apparatus than the communication apparatus. The network device or the apparatus in the network device may be further configured to perform any method performed by the network device in the method embodiments in FIG. 3. Details are not described herein again.

The processor and the transceiver described in this application may be implemented on an integrated circuit (IC), an analog IC, a radio frequency integrated circuit (RFIC), a mixed-signal IC, an application-specific integrated circuit (ASIC), a printed circuit board (PCB), an electronic device, or the like. The processor and the transceiver may be manufactured by using various IC process technologies, for example, complementary metal oxide semiconductor (CMOS), N-type metal oxide semiconductor (NMOS), P-type metal oxide semiconductor (PMOS), bipolar junction transistor (BJT), bipolar CMOS (BiCMOS), silicon germanium (SiGe), and gallium arsenide (GaAs).

The communication apparatus described in the foregoing embodiments may be a terminal device or a network device. However, a range of the apparatus described in this application is not limited thereto, and a structure of the communication apparatus may not be limited by FIG. 10. The apparatus may be an independent device, or may be a part of a larger device. For example, the communication apparatus may be:
(1) an independent integrated circuit IC, a chip, a chip system, or a subsystem;
(2) a set having one or more ICs, where optionally, the IC set may include a storage component configured to store data and/or instructions;
(3) an ASIC, for example, a modem (MSM);
(4) a module that can be embedded in another device; or
(5) the terminal device or the network device above.

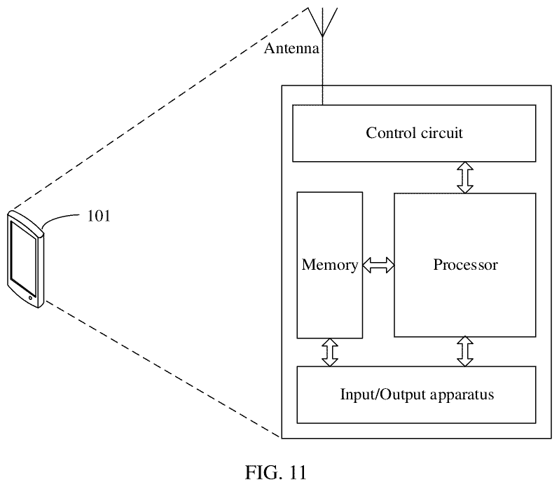

FIG. 11 is a diagram of a structure of a terminal device according to an embodiment of this application. For ease of description, FIG. 11 shows only main components of the terminal device. As shown in FIG. 11, the terminal device 101 includes a processor, a memory, a control circuit, an antenna, and an input/output apparatus. The processor is mainly configured to: process a communication protocol and communication data, control the entire terminal device, execute a software program, and process data of the software program. The memory is mainly configured to store software program and data. The control circuit is mainly configured to: perform conversion between a baseband signal and a radio frequency signal, and process the radio frequency signal. The antenna is mainly configured to receive and send a radio frequency signal in a form of an electromagnetic wave. The input/output apparatus, for example, a touchscreen, a display, or a keyboard, is mainly configured to: receive data input by a user and output data to the user.

After the terminal device is powered on, the processor may read the software program in the memory, parse and execute instructions of the software program, and process data of the software program. When data needs to be sent in a wireless manner, the processor performs baseband processing on the to-be-sent data, and outputs a baseband signal to the control circuit. The control circuit processes the baseband signal to obtain a radio frequency signal, and sends the radio frequency signal to the outside in an electromagnetic wave form through the antenna. When data is sent to the terminal device, the control circuit receives a radio frequency signal through the antenna. The radio frequency signal is further converted into a baseband signal, and the baseband signal is output to the processor. The processor converts the baseband signal into data, and processes the data.

For ease of description, FIG. 11 shows only one memory and one processor. An actual terminal device may include a plurality of processors and memories. The memory may also be referred to as a storage medium, a storage device, or the like. This is not limited in embodiments of this application.

In an optional implementation, the processor may include a baseband processor and a central processing unit. The baseband processor is mainly configured to process the communication protocol and the communication data. The central processing unit is mainly configured to control the entire terminal device, execute the software program, and process the data of the software program. The processor in FIG. 11 integrates functions of the baseband processor and the central processing unit. A person skilled in the art may understand that the baseband processor and the central processing unit may be processors independent of each other, and are interconnected by using a technology, for example, a bus. A person skilled in the art may understand that the terminal device may include a plurality of baseband processors to adapt to different network standards, the terminal device may include a plurality of central processing units to enhance processing capabilities of the terminal device, and components of the terminal device may be connected through various buses. The baseband processor may also be referred to as a baseband processing circuit or a baseband processing chip. The central processing unit may also be referred to as a central processing circuit or a central processing chip. A function of processing the communication protocol and the communication data may be built in the processor, or may be stored in the memory in a form of a software program, and the processor executes the software program to implement a baseband processing function.

In an example, the antenna and the control circuit that have receiving and sending functions may be considered as a transceiver unit of the terminal device 101, and the processor having a processing function may be considered as a processing unit of the terminal device 101. The transceiver unit may also be referred to as a transceiver, a transceiver machine, a transceiver apparatus, or the like. Optionally, a component that is in the transceiver unit and that is configured to implement a receiving function may be considered as a receiving unit, and a component that is in the transceiver unit and that is configured to implement a sending function may be considered as a sending unit. In other words, the transceiver unit includes the receiving unit and the sending unit. For example, the receiving unit may also be referred to as a receiver machine, a receiver, a receiving circuit, or the like, and the sending unit may also be referred to as a transmitter machine, a transmitter, a transmitting circuit, or the like. Optionally, the receiving unit and the sending unit may be one integrated unit, or may be a plurality of independent units. The receiving unit and the sending unit may be at one geographical location, or may be distributed at a plurality of geographical locations.

In an embodiment, the transceiver unit is configured to perform an operation performed by the transceiver unit 901 in the foregoing embodiments. The processing unit is configured to perform an operation performed by the processing unit 902 in the foregoing embodiments. The terminal device 101 may be further configured to perform any method performed by the terminal device or the network device in the method embodiments in FIG. 3. Details are not described herein again.

An embodiment of this application further provides a computer-readable storage medium. The computer-readable storage medium stores a computer program. When the program is executed by a processor, a procedure related to the terminal device in the communication method provided in the foregoing method embodiments can be implemented.

An embodiment of this application further provides a computer-readable storage medium. The computer-readable storage medium stores a computer program. When the program is executed by a processor, a procedure related to the network device in the communication method provided in the foregoing method embodiments can be implemented.

An embodiment of this application further provides a computer program product. When the computer program product is run on a computer or a processor, the computer or the processor is enabled to perform one or more steps in any one of the foregoing communication methods. When each component module of the foregoing device is implemented in a form of a software functional unit and sold or used as an independent product, the component module may be stored in a computer-readable storage medium.

An embodiment of this application further provides a chip system, including at least one processor and a communication interface. The communication interface and the at least one processor are interconnected through a line. The at least one processor is configured to run a computer program or instructions, to perform some or all of the steps recorded in the method embodiments in FIG. 3. The chip system may include a chip, or may include a chip and another discrete component.

An embodiment of this application further provides a communication system. The system includes a terminal device and a network device. For detailed descriptions, refer to any communication method shown in FIG. 3.

It should be understood that the memory described in embodiments of this application may be a volatile memory or a non-volatile memory, or may include both a volatile memory and a non-volatile memory. The non-volatile memory may be a hard disk drive (HDD), a solid-state drive (SSD), a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. By way of example, and not limitation, RAMs in many forms may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM). The memory is any other medium that can carry or store expected program code in a form of an instruction or a data structure and that can be accessed by a computer, but is not limited thereto. The memory in embodiments of this application may alternatively be a circuit or any other apparatus that can implement a storage function, and is configured to store program instructions and/or data.

It should be further understood that the processor in embodiments of this application may be a central processing unit (CPU), or may be another general-purpose processor, a digital signal processor (DSP), an application-specific integrated circuit (ASIC), a field programmable gate array (FPGA), another programmable logic device, a discrete gate or a transistor logic device, a discrete hardware component, or the like. The general-purpose processor may be a microprocessor, or the processor may be any conventional processor or the like.

It should be noted that, when the processor is a general-purpose processor, a DSP, an ASIC, an FPGA or another programmable logic device, a discrete gate or a transistor logic device, or a discrete hardware component, the memory (storage module) is integrated into the processor.

It should be noted that the memory described in this specification aims to include but is not limited to these memories and any memory of another proper type.

It should be understood that sequence numbers of the foregoing processes do not mean execution sequences in various embodiments of this application. The execution sequences of the processes should be determined according to functions and internal logic of the processes, and should not be construed as any limitation on the implementation processes of embodiments of this application.

A person of ordinary skill in the art may be aware that units and algorithm steps in the examples described with reference to embodiments provided in this specification may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiments are merely examples. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located at one location, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units are integrated into one unit.

When functions are implemented in a form of a software functional unit and sold or used as an independent product, the functions may be stored in a computer-readable storage medium. Based on such an understanding, the technical solutions of this application essentially, or the part contributing to the technologies, or some of the technical solutions may be implemented in a form of a software product. The computer software product is stored in a storage medium, and includes several instructions for indicating a computer device (which may be a personal computer, a server, or a network device) to perform all or a part of the steps of the methods described in embodiments of this application. The foregoing storage medium includes any medium that can store program code, for example, a USB flash drive, a removable hard disk, a ROM, a RAM, a magnetic disk, or an optical disc.

A sequence of the steps of the method in embodiments of this application may be adjusted, combined, or removed based on an actual requirement. Steps in each embodiment may be partially performed (for example, the terminal device may not perform the steps performed by the terminal device in the foregoing embodiments). An execution sequence of different steps can be changed. Embodiments described in this specification may be combined with other embodiments, different embodiments may be combined with each other, and different steps of different embodiments in this specification may be combined.

The modules/units in the apparatus in embodiments of this application may be combined, divided, and deleted based on an actual requirement.

“Embodiment” described in this specification means that a particular feature, structure, or characteristic described with reference to embodiments may be included in at least one of embodiments of this application. The phrase shown in various locations in this specification may not necessarily refer to a same embodiment, and is not an independent or optional embodiment exclusive from another embodiment.

In embodiments of this application, the terms “first”, “second”, “third”, “fourth”, and the like (if any) are intended to distinguish between similar objects but do not necessarily indicate a specific order or sequence.

In embodiments of this application, “include” may indicate an inclusion relationship, or an equal relationship. For example, if A includes B, A may include other content in addition to B, or A and B are the same content.

In the descriptions of this application, unless otherwise specified, “/” represents an “or” relationship between associated objects. For example, A/B may represent A or B. In this application, “and/or” describes only an association relationship for describing associated objects and indicates that three relationships may exist. For example, A and/or B may indicate the following three cases: Only A exists, both A and B exist, and only B exists. A and B may be singular or plural. In addition, in the descriptions of this application, unless otherwise specified, “a plurality of” means two or more. The term “at least one of the following items (pieces)” or an expression similar to the term indicates any combination of the items, including any combination of one single item (piece) or plural items (pieces). For example, at least one (piece) of a, b, or c may represent a, b, c, a and b, a and c, b and c, or a, b, and c, where a, b, and c may be singular or plural.

In conclusion, the foregoing embodiments are merely intended for describing the technical solutions of this application, but not for limiting this application. Although this application is described in detail with reference to the foregoing embodiments, a person of ordinary skill in the art should understand that modifications may still be made to the technical solutions described in the foregoing embodiments or equivalent replacements may still be made to some technical features thereof, without departing from the scope of the technical solutions of embodiments of this application.

1. A communication method, comprising:
receiving a reference signal, wherein there is a first association relationship between information about the reference signal and scheduling information of data transmission, and the scheduling information comprises at least one of the following of the data transmission: a time domain resource, a frequency domain resource, a modulation scheme, a code rate, a transmission configuration indication, a repetition quantity, information about a demodulation reference signal, a pattern, a redundancy version, a new data indicator, transmission power information, or a transmission type indication; and
performing the data transmission based on the scheduling information.

2. The communication method according to claim 1, wherein the information about the reference signal comprises at least one of the following of the reference signal: a signal class, a sequence parameter, a time domain resource, a frequency domain resource, a transmission configuration indication, or a pattern.

3. The communication method according to claim 1, further comprising:
receiving configuration information, wherein the configuration information indicates one or more candidate values of the information about the reference signal, and there is a second association relationship between the candidate value and the one or more pieces of scheduling information; or the configuration information indicates a second association relationship, and the second association relationship indicates one or more candidate values of the information about the reference signal; and the second association relationship comprises the first association relationship; and
receiving the reference signal based on the configuration information.

4. The communication method according to claim 2, wherein the signal class of the reference signal comprises at least one of the following: a channel state information reference signal (CSI-RS), a demodulation reference signal DMRS, a phase tracking reference signal PT-RS, a sounding reference signal SRS, or a reference signal downlink control information RS DCI.

5. The communication method according to claim 2, wherein the sequence parameter comprises at least one of the following of a sequence: a sequence type, a scrambling identifier, a root identifier, or a cyclic shift.

6. The communication method according to claim 2, further comprising:
determining a transmission type of the data transmission based on the signal class of the reference signal.

7. The communication method according to claim 1, wherein a time-frequency resource for the data transmission and a time-frequency resource for the reference signal meet at least one of the following:
the frequency domain resource for the data transmission is the same as the frequency domain resource for the reference signal;
the information about the reference signal indicates that there is a frequency domain offset between the frequency domain resource for the data transmission and the frequency domain resource for the reference signal;
the time domain resource for the data transmission is the same as the time domain resource for the reference signal; or
the information about the reference signal indicates that there is a time domain offset between the time domain resource for the data transmission and the time domain resource for the reference signal.

8. The communication method according to claim 1, wherein the time domain resource for the data transmission comprises a quantity of time domain symbols occupied for one single data transmission, and the information about the reference signal indicates the quantity of time domain symbols.

9. The communication method according to claim 1, wherein the scheduling information comprises first information and second information, and there is a third association relationship between the first information and the second information; and
the communication method further comprises:
determining the second information based on the first information and the third association relationship.

10. A communication method, comprising:
sending a reference signal, wherein there is a first association relationship between information about the reference signal and scheduling information of data transmission, and the scheduling information comprises at least one of the following of the data transmission: a time domain resource, a frequency domain resource, a modulation scheme, a code rate, a transmission configuration indication, a repetition quantity, information about a demodulation reference signal, a pattern, a redundancy version, a new data indicator, transmission power information, or a transmission type indication; and
performing the data transmission based on the scheduling information.

11. The communication method according to claim 10, wherein the information about the reference signal comprises at least one of the following of the reference signal: a signal class, a sequence parameter, a time domain resource, a frequency domain resource, a transmission configuration indication, or a pattern.

12. The communication method according to claim 10, further comprising:
sending configuration information, wherein the configuration information indicates one or more candidate values of the information about the reference signal, and there is a second association relationship between the candidate value and the one or more pieces of scheduling information; or the configuration information indicates a second association relationship, and the second association relationship indicates one or more candidate values of the information about the reference signal; and the second association relationship comprises the first association relationship; and
sending the reference signal based on the configuration information.

13. The communication method according to claim 11, wherein the signal class of the reference signal comprises at least one of the following: a CSI-RS, a DMRS, a PT-RS, an SRS, or an RS DCI.

14. The communication method according to claim 11, wherein the sequence parameter comprises at least one of the following of a sequence: a sequence type, a scrambling identifier, a root identifier, or a cyclic shift.

15. The communication method according to claim 10, wherein a time-frequency resource for the data transmission and a time-frequency resource for the reference signal meet at least one of the following:
the frequency domain resource for the data transmission is the same as the frequency domain resource for the reference signal;
the information about the reference signal indicates that there is a frequency domain offset between the frequency domain resource for the data transmission and the frequency domain resource for the reference signal;
the time domain resource for the data transmission is the same as the time domain resource for the reference signal; or
the information about the reference signal indicates that there is a time domain offset between the time domain resource for the data transmission and the time domain resource for the reference signal.

16. The communication method according to claim 10, wherein the time domain resource for the data transmission comprises a quantity of time domain symbols occupied for one single data transmission, and the information about the reference signal indicates the quantity of time domain symbols.

17. The communication method according to claim 10, wherein the scheduling information of the data transmission comprises first information and second information, and there is a third association relationship between the first information and the second information.

18. A non-transitory computer-readable storage medium, wherein storage medium coupled to one or more processors and storing programming instructions for execution by the one or more processors, the programming instructions instruct the processor to:
receiving a reference signal, wherein there is a first association relationship between information about the reference signal and scheduling information of data transmission, and the scheduling information comprises at least one of the following of the data transmission: a time domain resource, a frequency domain resource, a modulation scheme, a code rate, a transmission configuration indication, a repetition quantity, information about a demodulation reference signal, a pattern, a redundancy version, a new data indicator, transmission power information, or a transmission type indication; and
performing the data transmission based on the scheduling information.
